(19) United States
(12) Patent Application Publication
(10) Pub. No.: US 2026/0103084 A1
(43) Pub. Date: Apr. 16, 2026

(54) SYSTEMS AND METHODS FOR HARVESTING AERODYNAMIC ENERGY

(71) Applicants: Tyrone L. DOTSON, Jr., Wethersfield, CT (US); Jeremiah RABE, Killingworth, CT (US)

(72) Inventors: Tyrone L. DOTSON, Jr., Wethersfield, CT (US); Jeremiah RABE, Killingworth, CT (US)

(21) Appl. No.: 19/355,528

(22) Filed: Oct. 10, 2025

Related U.S. Application Data
(60) Provisional application No. 63/706,233, filed on Oct. 11, 2024.

(51) Int. Cl. B60L 8/00; B60L 50/60; F03D 3/00; F03D 3/06; F03D 7/06; F03D 9/32

(52) U.S. Cl. CPC B60L 8/006; B60L 50/60; F03D 3/002; F03D 3/061; F03D 7/06; F03D 9/32; F05B 2220/706; F05B 2250/25

(57) ABSTRACT

A system for harvesting kinetic wind energy for a vehicle includes a turbine drivingly connected to a motor/generator. The turbine is configured to be driven by the force of air encountered during operation of the vehicle and/or from wind when parked, and to drive the motor/generator to generate electrical power.

### CROSS-REFERENCE TO RELATED APPLICATIONS

This application claims the benefit of, and priority to, U.S. Provisional Application Ser. No. 63/706,233, filed on Oct. 11, 2024, which is hereby incorporated by reference herein in its entirety.

### FIELD OF THE INVENTION

The present invention relates generally to systems and methods for harvesting otherwise wasted kinetic wind energy and kinetic energy from tire/wheel motion, more particularly, to an electric vehicle having systems for generating electrical power from kinetic wind energy.

### BACKGROUND OF THE INVENTION

Environmental pollution, noise and depletion of crude oil reserves due to the increasing use of internal combustion engine (ICE) powered vehicles continue to be of significant concern. Electrically powered/hybrid vehicles are known to solve some of the problems associated with fossil fuel powered vehicles, however, electrically powered/hybrid vehicles have certain drawbacks as compared to vehicles powered by conventional ICE. For example, these drawbacks include limited travel range between battery recharging and excessive time required for recharging the batteries. Despite advances in battery technology and charging infrastructure, the average travel distance between battery recharging for currently available electrically powered/hybrid vehicles is considerably less than fossil fuel powered vehicles. In addition, it can take several hours to recharge the batteries while the vehicle remains inoperative. Moreover, electric vehicles (EVs) are generally heavier than conventional ICE powered vehicles, due mainly to the weight of the batteries and the weight of the chassis (which must be made more robust to handle the extra battery weight). This increased weight results in reduced efficiency of the vehicle, as a whole.

As will be appreciated, the current state of electric vehicles poses challenges across various sectors. Businesses utilizing large EVs face significant hurdles due to limited range and extended charging times. These vehicles, equipped with massive batteries to handle their size and payload, often struggle to complete their routes without inducing range anxiety. This uncertainty can jeopardize delivery schedules and overall mission success. Similarly, first responders using electric vehicles often must rely on backup fossil fuel powered vehicles due to range and charging constraints. Armed forces wishing to deploy electric vehicles face comparable difficulties in critical situations, as existing technologies cannot provide the quick charging times and extended ranges required for their operations. While backup power sources like fossil fuel generators or fuel cells can help, there remains a pressing need for technologies that can further extend the range of onboard energy storage systems, especially for these larger, energy-intensive vehicles.

In view of the above, there is a need for an electric vehicle and systems and methods therefor that eliminate or decrease range anxiety by providing electric/hybrid vehicles with increased range, decrease charging infrastructure constraints by reducing the charging frequency, and eliminate and/or reduce organizational risks that have heretofore been present with the use of existing electric vehicles.

### SUMMARY OF THE INVENTION

It is an object of the present invention to provide an electric vehicle.

It is another object of the present invention to provide an electric vehicle having one or more systems or devices for converting kinetic wind energy into electrical power for powering or recharging a battery of the electric vehicle.

It is another object of the present invention having a system or device for generating electrical power from wheel kinetic energy (rotation of the wheel) during vehicle motion.

It is another object of the present invention to provide an electric vehicle having increased range.

It is another object of the present invention to provide an electric vehicle having reduced weight.

These and other objects are achieved by the present invention.

According to an embodiment of the invention, a system for harvesting kinetic wind energy includes a turbine assembly configured for positioning within an air flow passageway within a vehicle, the turbine assembly being configured to receive an inlet flow of air from the air flow passageway, and a motor/generator drivingly connected to the turbine assembly and being configured to generate electrical power from the inlet flow of air.

According to another embodiment of the invention, a vehicle includes a plurality of wheels, at least one electric motor configured to provide motive power for driving the plurality of wheels, at least one rechargeable battery electrically connected to the at least one electric motor for powering the at least one electric motor, at least one turbine assembly configured to receive a flow of air and to convert the flow of air into electrical power.

According to yet another embodiment of the invention, a method for harvesting kinetic wind energy includes routing a flow of air during operation of a vehicle into an air flow pathway of the vehicle, directing the flow of air into a turbine assembly to rotate a blade assembly of the turbine assembly, and, with the rotational output of the blade assembly, driving a motor/generator to produce electrical power for consumption by the vehicle and/or storage in at least one battery of the vehicle.

According to yet another embodiment, a turbine assembly includes an inlet passage configured to receive a flow of air, a turbine wheel mounted on an axis and being configured to receive the flow of air from the turbine inlet passage, an outlet passage configured to receive the flow of air from the turbine wheel, a plurality of guide vanes, the guide vanes being selectively adjustable to control an amount of air provided to the turbine wheel, and a mechanical adjustment mechanism operable to control a position of the plurality of guide vanes.

### BRIEF DESCRIPTION OF THE DRAWINGS

The present invention will be better understood from reading the following description of non-limiting embodiments, with reference to the attached drawings, wherein below:

FIG. 1 is a perspective view of an electric vehicle according to an embodiment of the present invention.

FIG. 2 is another perspective view of the electric vehicle of FIG. 1.

FIG. 3 is a front elevational view of a portion of the electric vehicle of FIG. 1, showing a system for generating electrical power from wind energy.

FIG. 4 is a front, plan view of a turbine of the system of FIG. 3.

FIG. 5 is a perspective view of the turbine of FIG. 4.

FIG. 6 is a side-elevational view of the system of FIG. 3.

FIG. 7 is a cross-sectional view of the device of FIG. 3, taken along line A-A of FIG. 6.

FIG. 8 is a side, cross-sectional view of the system of FIG. 3.

FIG. 9 is a front elevational view of the system for generating electrical power from wind energy, deployed on a truck.

FIG. 10 is a front elevational view of another system for generating electrical power from kinetic wind energy, according to another embodiment of the present invention.

FIG. 11 is a side elevational view of the system of FIG. 10.

FIG. 12 is a perspective view of a portion of the system of FIG. 10.

FIG. 13 is a cross-sectional view of the system of FIG. 10, taken along line A-A of FIG. 11.

FIG. 14 is a perspective view of the system of FIG. 10.

FIG. 15A is a front elevational view of a portion of an electric vehicle having a plurality of energy harvesting devices.

FIG. 15B is a perspective view of another electric vehicle having systems for harvesting kinetic wind energy.

FIG. 15C is another perspective view of the electric vehicle of FIG. 15B having systems for harvesting kinetic wind energy.

FIG. 16 is a perspective view of another system for generating electrical power from wind energy, according to another embodiment of the present invention.

FIG. 17 is a side elevational view of the system of FIG. 16.

FIG. 18 is another side elevational view of the system of FIG. 16.

FIG. 19 is a plan view of the system of FIG. 16.

FIG. 20 is a cross-sectional view of the system of FIG. 16, taken along line B-B of FIG. 19.

FIG. 21 is a perspective view of a turbine of the system of FIG. 16, according to an embodiment of the invention.

FIG. 22 is another perspective view of the turbine of FIG. 21.

FIG. 23 is a perspective, view of the turbine of FIG. 21.

FIG. 24 is a cross-sectional view of the system of FIG. 16, illustrating a cooling air flow pathway.

FIG. 25A is a top plan view of another system for generating electrical power from wind energy, shown positioned in a fog light area of a vehicle, according to another embodiment of the present invention.

FIG. 25B is an enlarged, top plan view of a portion of the system of FIG. 25A.

FIG. 25C is a side cross-sectional view of the system of FIG. 25A

FIG. 26A is an elevational view of a turbine of the system of FIG. 25A, according to an embodiment of the invention.

FIG. 26B is a cross-sectional view of the turbine of FIG. 26A, taken along line A-A of FIG. 26A.

FIG. 27 is a perspective view of a turbine device according to an embodiment of the invention.

FIG. 28 is a perspective view of an impeller/turbine device according to an embodiment of the invention.

FIGS. 29 and 30 are various views of an electric vehicle illustrating various locations where energy recovery systems/devices of the invention may be located.

FIG. 31 is a perspective view of a helix-style airfoil integrated in the side mirror of a vehicle, according to an embodiment of the invention.

FIG. 32 is a perspective view of bladeless power generator units positioned along a roofline and spoiler of a vehicle, respectively, according to an embodiment of the invention.

FIG. 33 is a perspective view of a system for generating electrical power from wind energy, according to another embodiment of the invention.

FIG. 34 is a cross-sectional view of the system of FIG. 33.

FIG. 35 is a plan view of a system for generating electrical power from wind energy in the form of a mixed-flow turbine, according to another embodiment of the invention.

FIG. 36 is a cross-sectional view of the mixed-flow turbine of FIG. 35.

FIG. 37 is a perspective view of a central cartridge assembly of the mixed-flow turbine of FIG. 36.

FIG. 38 is a perspective view of the central cartridge assembly of the mixed-flow turbine of FIG. 35, showing the adjustable vanes in the closed position.

FIG. 39 is another perspective view of the central cartridge assembly of the mixed-flow turbine of FIG. 35, showing the adjustable vanes in the open position.

FIG. 40A is an exploded, perspective view of the central cartridge assembly of the mixed-flow turbine of FIG. 35.

FIG. 40B is another exploded, perspective view of the central cartridge assembly of the mixed-flow turbine of FIG. 35.

FIG. 41A is a perspective view of a turbine wheel of the mixed-flow turbine of FIG. 35.

FIG. 41B is a plan view of the turbine wheel of FIG. 41A.

FIG. 41C is a cross-sectional view of the turbine wheel of FIG. 40A, taken along line A-A of FIG. 41B.

### DETAILED DESCRIPTION OF THE PREFERRED EMBODIMENT

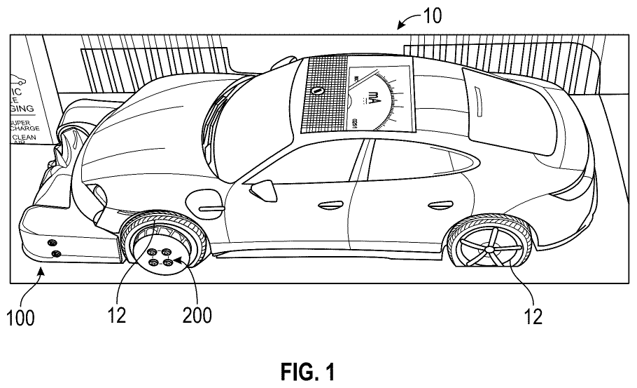

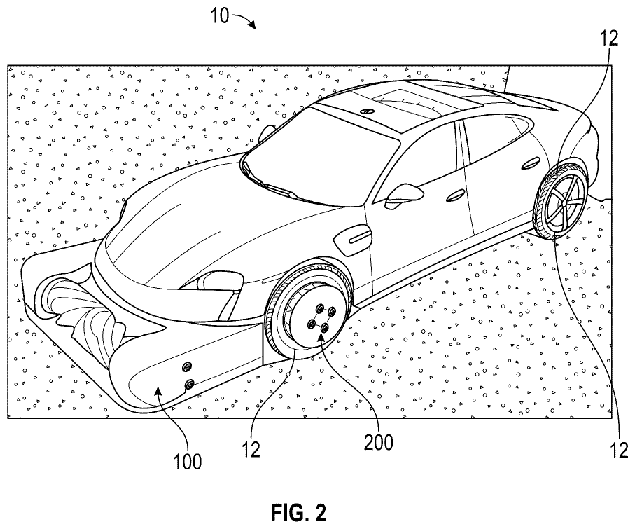

With reference to FIGS. 1 and 2, an exemplary electric vehicle 10 according to an embodiment of the present invention is illustrated. The electric vehicle 10 is of any type of electrically powered/hybrid vehicle known in the art and includes, for example, four wheels 12 and two rotating axles. The vehicle 10 has at least one electric motor, also referred to as a traction motor, (not shown) mounted therein, which is connected to the vehicle transmission and drivetrain for propelling the vehicle. In an embodiment, the electric motor receives electrical power from a controller unit and/or inverter, and which receives power from an array of rechargeable batteries (not shown) or other rechargeable energy storage system (such as a flywheel or other chemical storage system). The controller unit controls the electric motor's speed using a closed-loop feedback control system. The driver presses an accelerator pedal to control the speed of the vehicle 10; this throttle position signal from the potentiometer (or other positioning sensor such as a hall effect sensor) changes accordingly. The throttle signal sends a corresponding throttle position (analog or digital) to the controller, which is translated into a +, 0, or − torque request to be delivered by the electric car's motor. In an embodiment, the vehicle 10 may also include one or more accessory batteries (not shown) for powering the normal electrical components and other vehicle functions, namely the lights, radio, horn, fan, heater, defogger and other units.

As further shown in FIGS. 1 and 2, the electric vehicle 10 may include one or more systems and devices for harvesting kinetic wind energy and, in particular, for utilizing the aerodynamic energy from vehicle motion to generate electrical power for propelling the vehicle and/or recharging one or more batteries on board the vehicle. For example, the electric vehicle 10 may include a first system 100 located at the front of the vehicle for harvesting aerodynamic energy, also referred to herein as kinetic wind energy, and a second system 200 integrated with one or more of the wheels 12 for harvesting kinetic wind energy. As used herein, ‘kinetic wind energy’ refers to the kinetic energy present in the airflow encountered by a moving vehicle, which includes both the ram air pressure created by the vehicle's forward motion through ambient air and the relative wind velocity experienced by the vehicle. This kinetic energy is available for harvesting regardless of whether ambient wind is present, as it is generated by the vehicle's own motion through the air mass as well as a stationary vehicle parked in wind or an airflow.

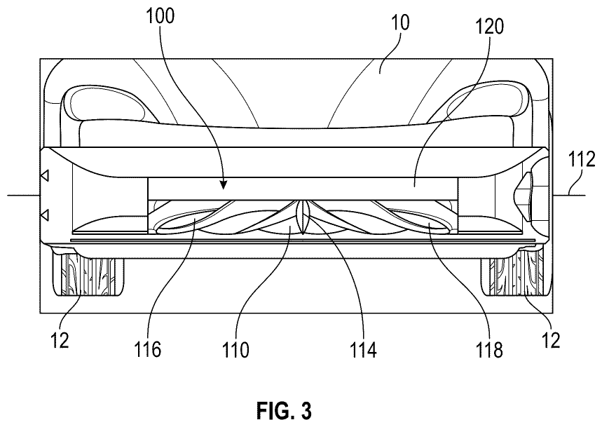

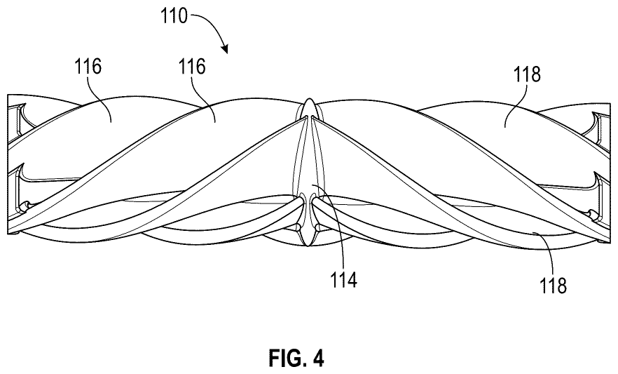

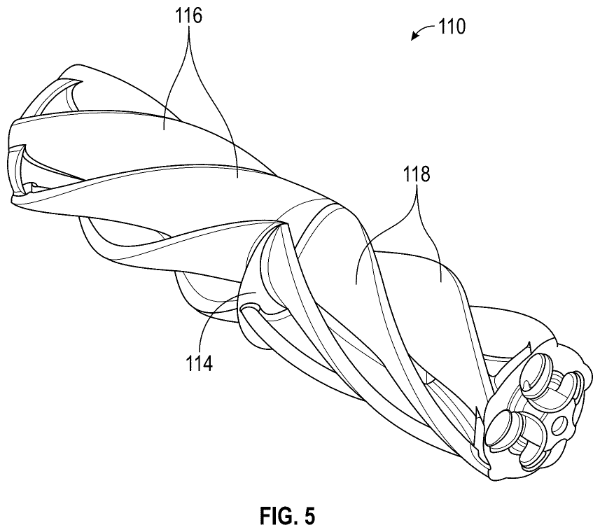

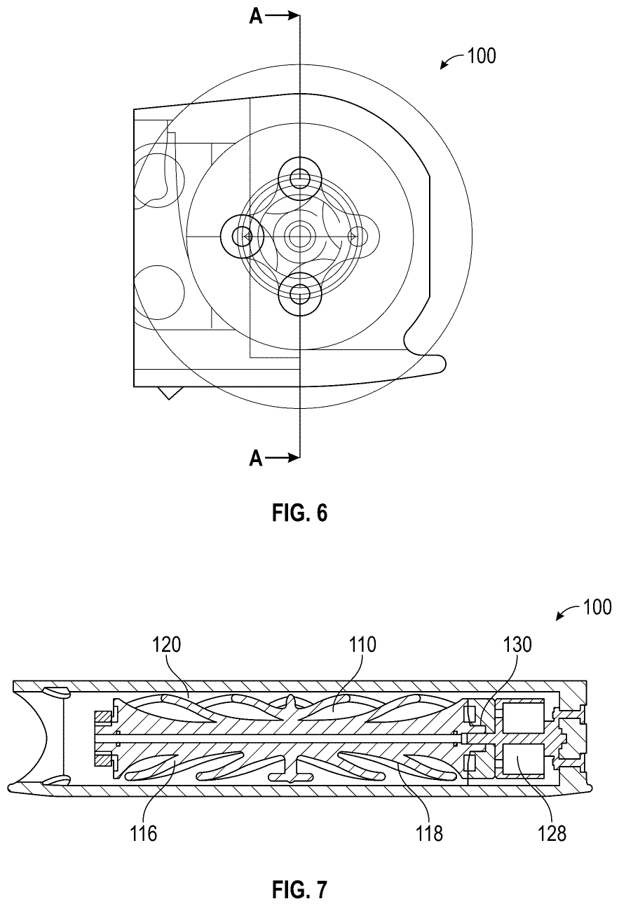

As best shown in FIGS. 3-8, in an embodiment, the first system 100 includes an airfoil or turbine 110 mounted for rotation about a horizontal axis at the front of the vehicle 10. For example, in an embodiment, the airfoil 110 may be mounted rearward of the bumper and/or bumper cover 120 of the vehicle 10 for rotation about axis 112. It is contemplated, however, that the airfoil 110 may be mounted forward of the bumper and bumper cover. Moreover, it is contemplated that the airfoil 110 may be located at a variety of other positions within the vehicle. As best shown in FIGS. 3-5, the airfoil 110 is generally cylindrical in shape and may include a midline 114, and respective sets of helical or spiral vanes 116, 118 located on opposing sides of the midline 114. In an embodiment, the airfoil is a single airfoil that extends across the vehicle. As illustrated, the vanes 116, 118 are angled and configured to direct airflow towards opposing sides of the vehicle as well as up and over the vehicle 10, as discussed below.

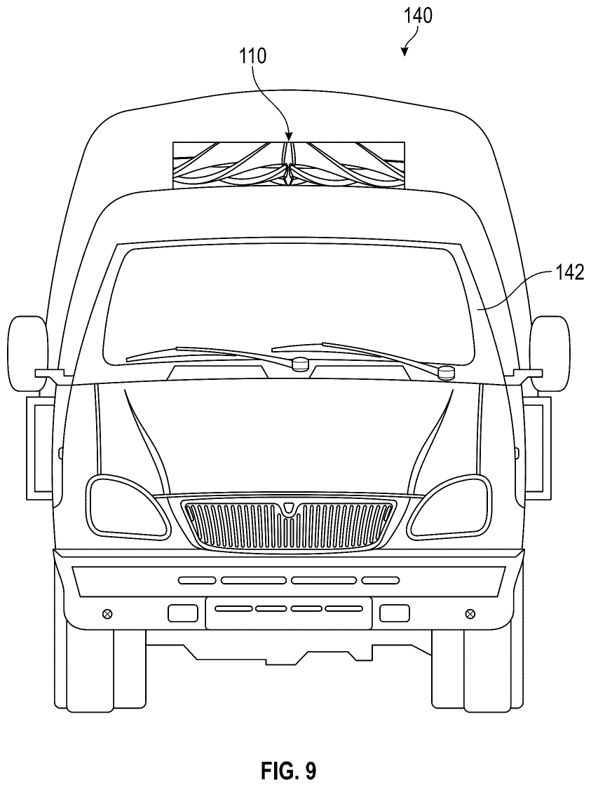

As best shown in FIG. 8, the airfoil 110 is generally housed within an enclosure 122. In an embodiment, the enclosure 122 may be at least partially formed by the configuration of the bumper cover 120. As shown in FIG. 8, the system 100 thus includes a high pressure air inlet 124 (for example, at a lower area of the airfoil 110), and a low pressure air outlet 126. In an embodiment, the low pressure air outlet 126 is located and configured so as to direct the air upwardly. It is contemplated, however, that the low pressure air outlet 126 may be configured and positioned so as to direct the air to the sides or to the rear. In the embodiments disclosed herein, airflow may pass through/past the turbine before or after passing through a heat exchanger (e.g., a radiator of a vehicle), as discussed in more detail hereinafter.

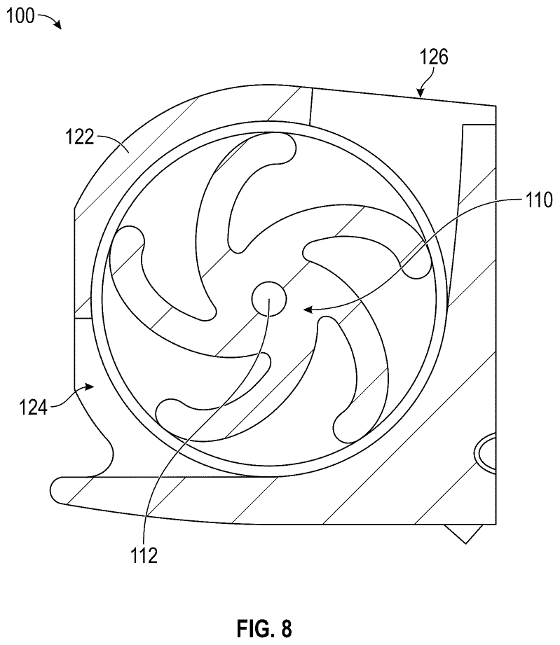

Referring now to FIG. 7, the system 100 further includes an electric motor/generator 128 having a shaft that is rotatably and drivingly coupled to the helical airfoil/turbine 110 by a coupling 130. In an embodiment, there may be an electric motor/generator connected to each end of the airfoil 110, although only a single electric motor/generator 128 at one end, centrally, or internally may be utilized.

In use, as the electric vehicle 10 is propelled forward by the electric motor(s), in a manner heretofore known in the art), air enters through inlet 124 where it drives the airfoil 110, causing the airfoil 110 to rotate due to the configuration of the vanes 116, 118. This rotation of the airfoil 110 is transmitted to the shaft of the motor/generator 128 through coupling 130, thus driving the motor/generator and generating electrical power. In an embodiment, the coupling 130 may be omitted such that a direct connection is present between the motor/generator 128 and the airfoil 110. This electrical power can then be utilized to power the electric motors that propel the vehicle, or to recharge the on-board batteries. In this respect, kinetic wind energy, namely, the force of the air as the vehicle moves therethrough, interacts with the airfoil 110, causing it to rotate. This kinetic wind energy is thus converted into a rotational force that drives generator/motor 128, thus generating electrical power which can be used or stored.

While the system 100 has been disclosed above as including a motor/generator having a shaft that is driven by the rotation of the airfoil 110, it is contemplated that other configurations are possible. In particular, in an embodiment, the generator (e.g., in the form of an axial flux motor generator) may be built into the airfoil 110 and may not need a coupling. In an embodiment, magnets may be imbedded or otherwise integrated into the airfoil (e.g., at the inside diameter, outside diameter, or an end of the airfoil 110 with a bearing and a stator interfacing with the magnets as the motor/generator). In an embodiment, the motor/generator 128 may be integrated into the airfoil 110 or in the center of the airfoil 110 to minimize torsional load through the airfoil 110. In particular, it is envisioned that a variety of driving arrangements may be present between the airfoil 110 and the motor/generator(s) 128, so long as rotation of the airfoil 110 drives the motor/generator 128 to generate electrical power.

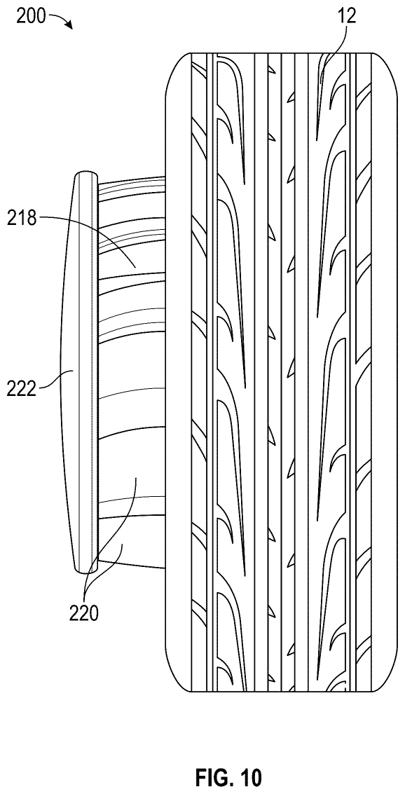

While the system 100 has been described above as intended for use in connection with electric vehicles such as passenger automobiles, it is not intended that the present invention be so limited in this regard. In particular, it is contemplated that the system 100 and airfoil 110 thereof can be utilized on trucks, trains, sports cars, buses, motorcycles, trolleys, semi-trucks, recreational vehicles, industrial vehicles, and other vehicles to recover kinetic wind energy to generate power and/or to create an “air blade” to direct air up over the vehicle, decreasing drag and increasing the overall efficiency of the vehicle. For example, FIG. 9 illustrates a truck 140 employing system 100 above the cab 142, which helps direct the air over the vehicle.

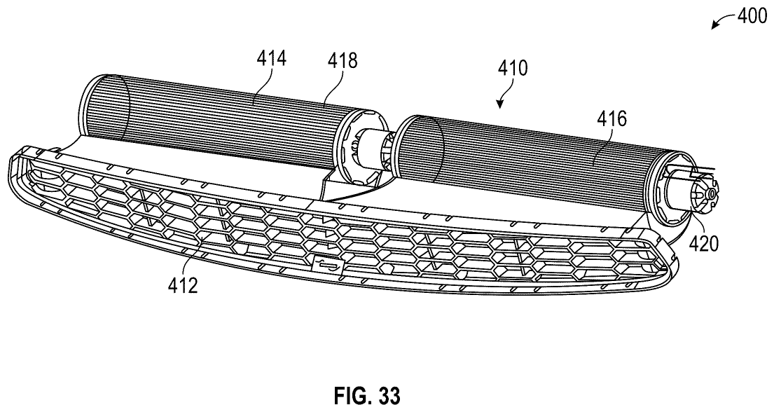

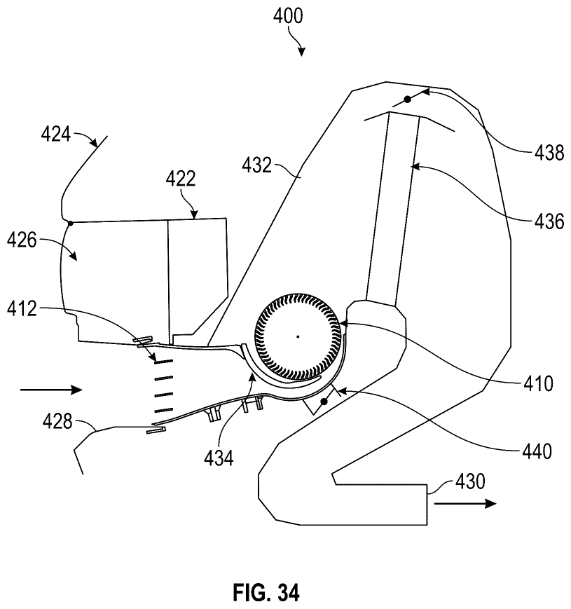

Turning now to FIGS. 33 and 34, another embodiment of a system 400 for harvesting kinetic wind energy according to an embodiment of the invention is illustrated. The system 400 is generally similar to system 100 described above, where like reference numerals designate like parts. As shown therein, however, airfoil or turbine 410 is configured as a cross-flow turbine in which air flows tangentially across the rotor. Like turbine 110, cross-flow turbine 410 is located rearward of a grille 412 of a vehicle at the front end thereof., although locations such as, for example, at a rear of the vehicle, are also possible without departing from the broader aspects of the invention. In an embodiment, as shown in FIG. 33, the cross-flow turbine 410 is comprised of one or more cross-flow turbine members 414, 416 rotatable about a common axis. The cross-flow turbine 410 includes a plurality of radial blades or fins 418, and is mounted at respective ends thereof on bearings. At one or either end of the cross-flow turbine 410 is mounted a motor/generator 420, which is configured to be driven by the cross-flow turbine 410. As further shown therein, and as is conventional, the vehicle includes a bumper 422, a bumper cover 424 and impact absorbing foam 426.

As best shown in FIG. 33, the grille 412 forms an inlet opening 428 for the flow of air (indicated by the arrow to the left of the figure), and the system 400 further includes an outlet 430 for the outlet flow of air (indicated by the arrow to the right of the figure), which define therebetween an air flow pathway 432. As illustrated, the cross-flow turbine is mounted downstream of the inlet opening 428. Intermediate the inlet opening 428 and the cross-flow turbine 410 is positioned a variable guide vane 434 which is arcuate in shape and extends a substantial entire length of the cross-flow turbine 410. While the guide vane 434 is illustrated as being arcuate in shape, other configurations are possible so long as the vane 434 is selectively moveable to control an amount of air that is permitted to pass thereby, as discussed below. The purposes of such guide vane 434 is to help direct and nozzle the available airflow and pressure to optimize drag, energy recovery, and thermal airflow needs. Moreover, within the air flow pathway 432 is located a heat exchanger 436 and a heat exchanger bypass valve 438. The bypass valve 438 is selectively controllable between an open position, in which air is permitted to pass through the air flow pathway 432 to the outlet 430 without passing through the heat exchanger 436, and a closed position in which substantially all of the air passing through air flow pathway 432 is forced to pass through the heat exchanger 436. In an embodiment, the heat exchanger 436 may be the radiator of the vehicle. In an embodiment, the heat exchanger may instead be condensers, evaporators, intercoolers, and other heat exchange devices.

The heat exchanger bypass valve 438 provides for proportional airflow management for bypassing thermal components when cooling is not required. This reduces heat exchanger flow restriction when thermal airflow needs are low, facilitates wind energy capture/utilization when the vehicle is parked/static, optimizes cold start up, and reduces parasitic losses. In an embodiment, the system is configured to default to the valve closed position in the event of, for example, an electrical failure, ensuring that vehicle cooling requirements are not compromised. In an embodiment, the heat exchanger bypass valve 438 may be any type of bypass mechanism or other proportional airflow management component(s) including valves, actuators, and control systems that enable selective airflow routing to optimize energy recovery by bypassing thermal components when cooling is not required, which is particularly beneficial for parked wind energy capture and cold startup operations.

Just rearward of the cross-flow turbine 410 is located a debris dump valve 440, which may be utilized to clean out debris from the area surrounding the cross-flow turbine 410. In this embodiment, and in any embodiments described in this application, the air flow pathway may have constant, increasing, decreasing, or variable cross-sectional area.

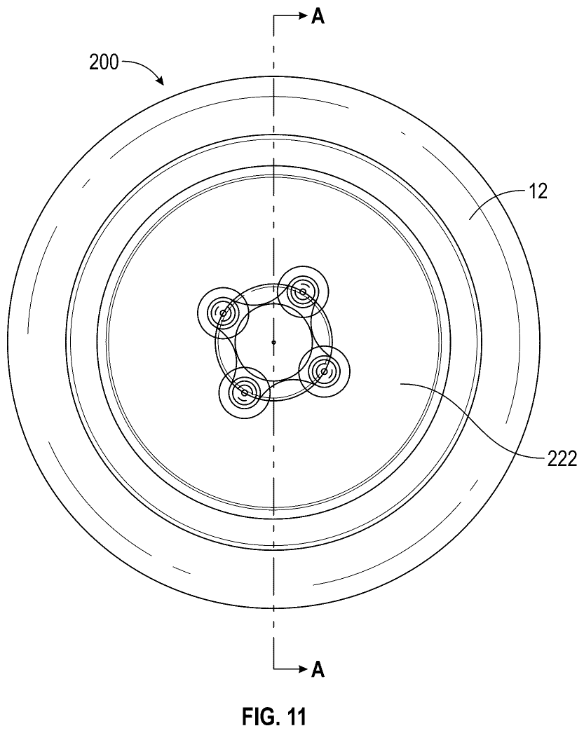

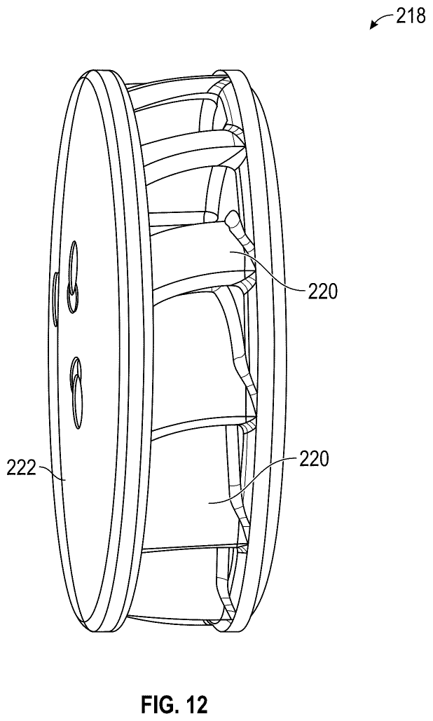

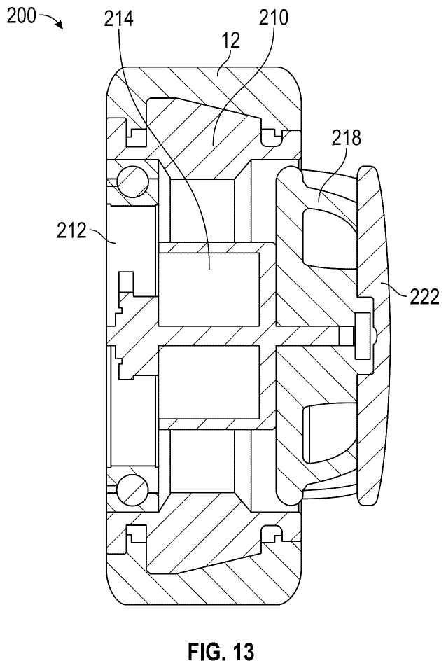

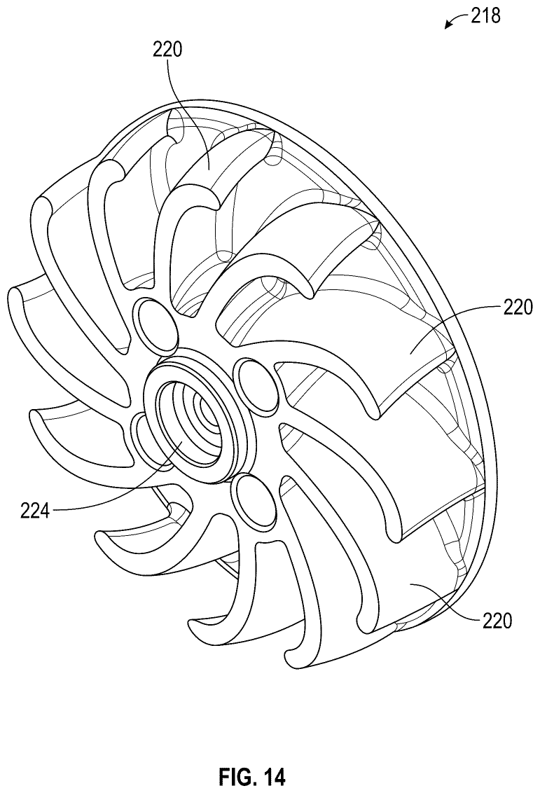

Referring now to FIGS. 10-14, system 200 for harvesting kinetic wind energy is illustrated. As shown therein, the system 200 includes a tire (e.g., wheel 12) mounted on a wheel or rim 210. The tire 12 and rim 210 are operatively connected to a wheel bearing 212, which connects the wheel 12 to the axle of the vehicle 10 and allows for smooth rotation of the wheels 12 with minimal friction, as is known in the art. In an embodiment, the wheel 12, rim 210 and wheel bearing 212 may be conventional components. As best shown in FIG. 13, the system 200 also includes a motor/generator 214 concentrically mounted within the wheel/rim 212. A turbine 218 having a plurality of vanes 220 or blades is drivingly coupled to the motor/generator 214 for driving the same. A variety of coupling arrangements are envisioned. For example, in an embodiment, the coupling may be a rotatable coupling (e.g., magnets in the turbine with a separate stator), although other configurations are possible so long as rotation of the turbine 218 is transmitted to, and provides a rotational input to, the motor/generator 214 to generate electrical power. In an embodiment, a cover 222 is coupled to the turbine 218.

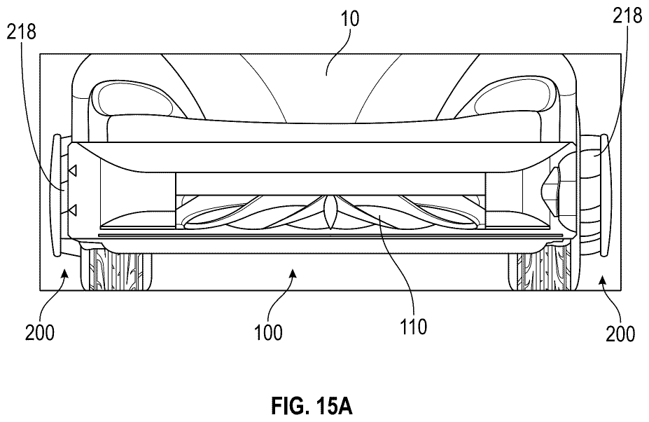

As shown in FIG. 14, in an embodiment, the turbine 218 is generally circular in shape and has a hub 224 that interfaces with the motor/generator 214. As shown therein, the plurality of vanes or blades 220 protrude from the hub 224 and are generally arcuate in shape. The hub 224 aligns to the generator 214 and can be affixed to the generator/generator rotor magnets. Alternatively, the magnets could also be imbedded in the turbine. While FIG. 10 illustrates the system 200 as protruding from the tire of the vehicle, it is contemplated that the turbine 218 may be nested within the wheel of the vehicle so as to not protrude outwardly therefrom. Moreover, in an embodiment, the turbine 218 may include a cover (not shown).

In use, as the electric vehicle 10 is propelled forward by the traction motor(s), in a manner heretofore known in the art), air or wind flow exerts force on the vanes 220 or blades of the turbine 218, generating rotational torque. This torque drives rotation of the turbine 218 about its rotational axis. The turbine 218 is rotatably coupled to the integral generator, where permanent magnets are typically embedded within the rotating component. As this rotor element spins relative to the stationary stator component, it induces electrical current in the stator windings. This integral design efficiently converts the wind's kinetic energy into electrical power, eliminating the need for a separate coupling mechanism between the turbine and motor/generator. This electrical power can then be utilized to power the traction motors that propel the vehicle, or to recharge the on-board batteries. In this respect, kinetic wind energy, namely, the force of the air as the vehicle moves therethrough, the wind, and turbine blades positioning to the wind create high and low pressure areas which impart forces on the airfoil turbine 218 causing it to rotate. This kinetic wind energy is thus converted into a rotational force that drives generator/motor 214, thus generating electrical power which can be used or stored. Importantly, rotation of the wheels and tires via vehicle movement also contributes to the rotation of the turbine 218.

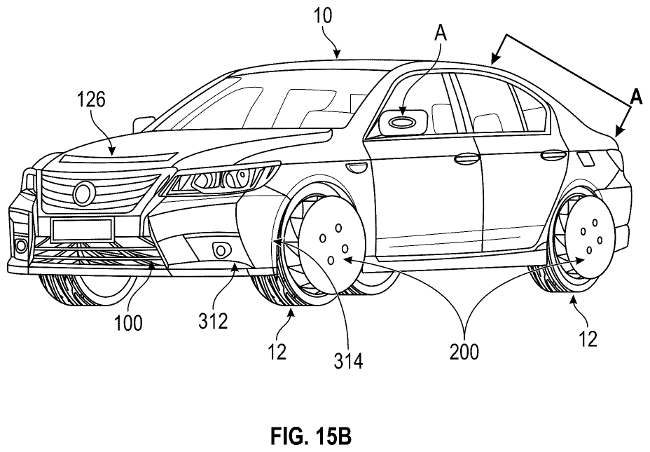

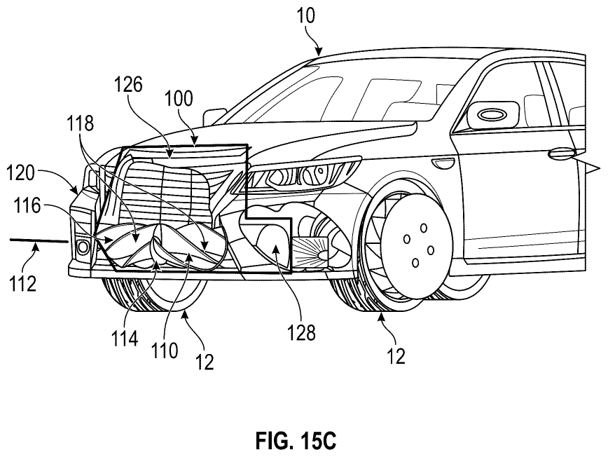

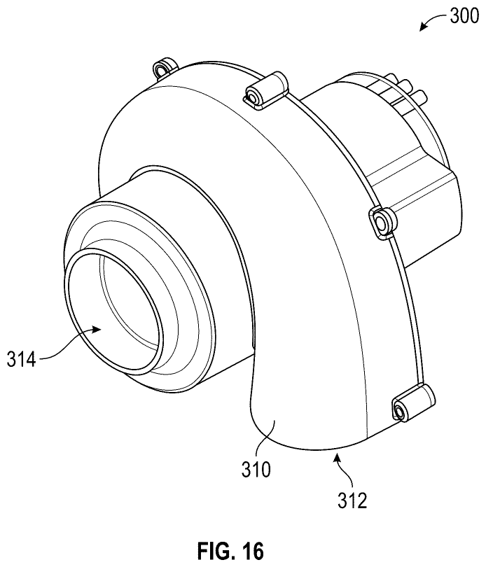

As shown in FIG. 15A, the systems 100, 200 described herein can be used separately or in combination with one another on a single vehicle 10. Moreover, it is contemplated that system 200 may be used on each wheel of the vehicle (or on both sides of a wheel in the case of, for example, a motorcycle), or fewer than all wheels, and the systems 200 can be operatively connected to individual, separate motor/generators, or a single, shared motor/generator. FIGS. 15B and 15C are perspective views of another electric vehicle having systems 100 and 200 for harvesting kinetic wind energy, and are intended to be only illustrative.

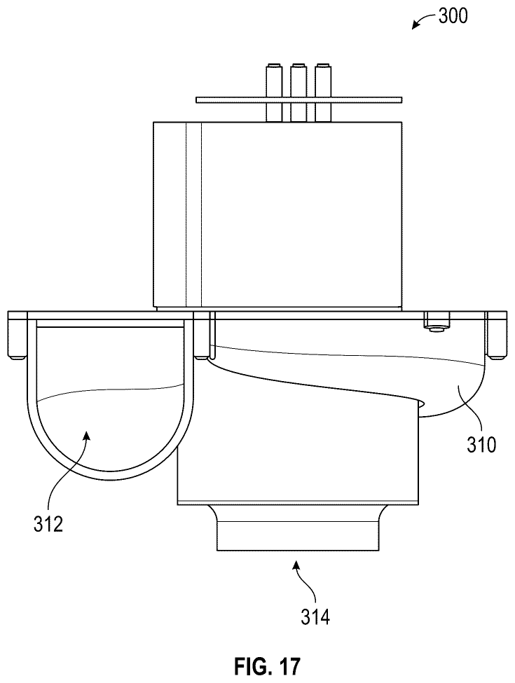

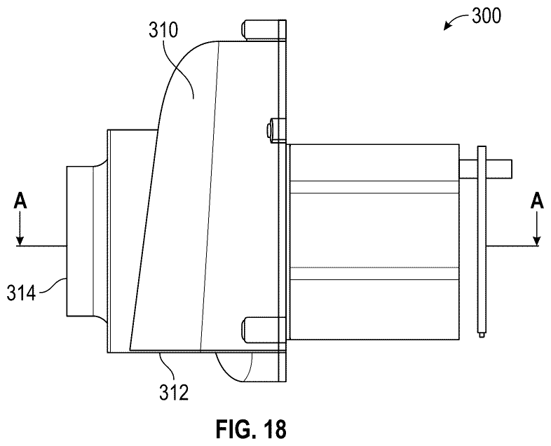

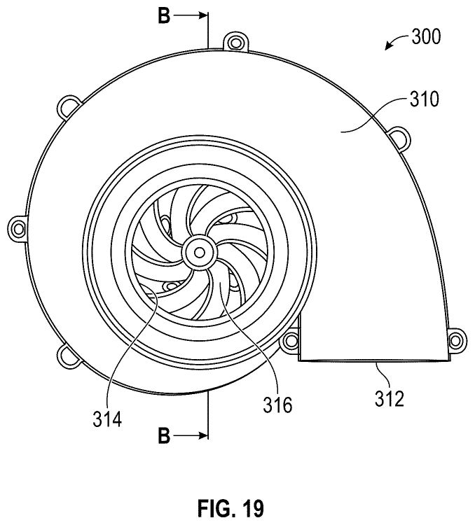

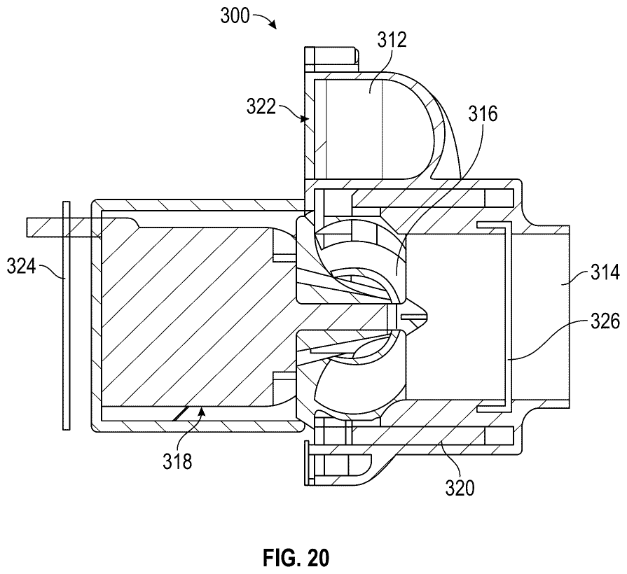

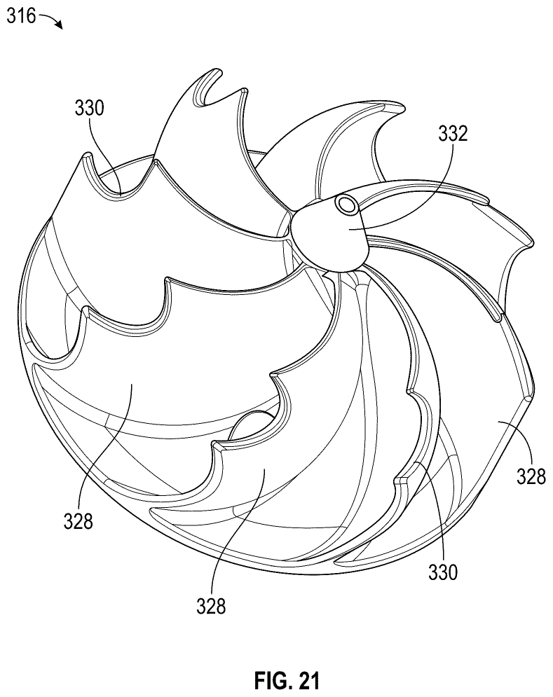

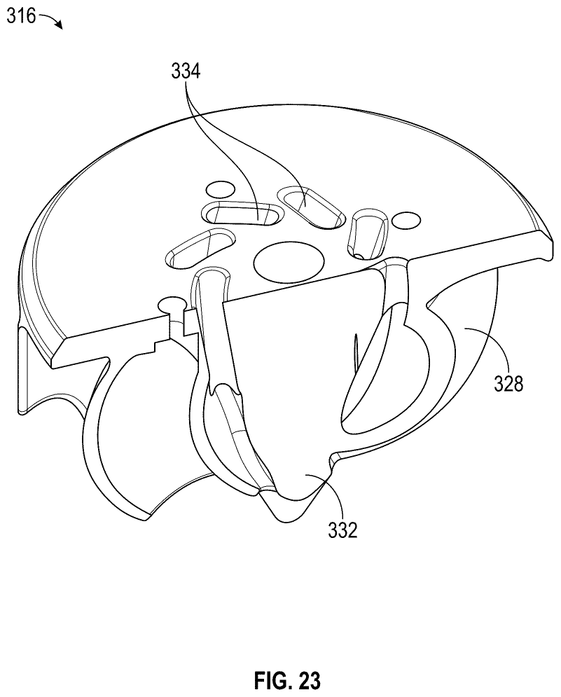

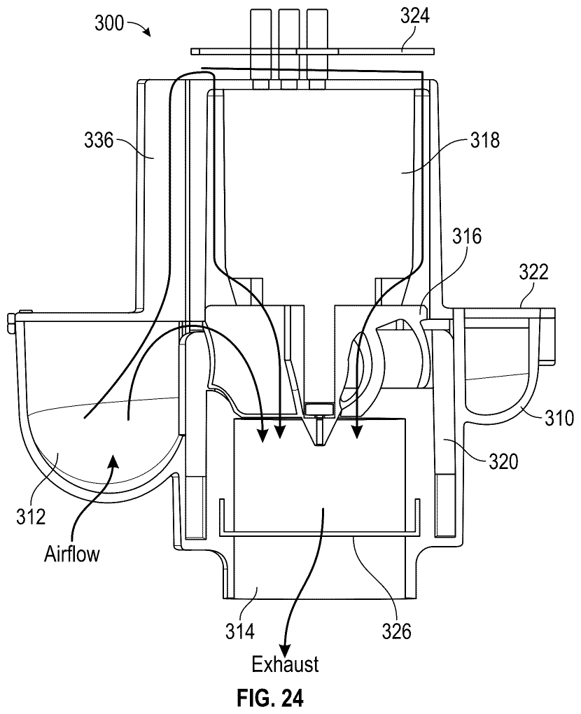

Turning now to FIGS. 16-24, another system 300 for harvesting kinetic wind energy and generating electrical power therefrom, for use on vehicles such as passenger automobiles, trucks, trains and the like, is illustrated. As shown therein, the system 300 generally takes the form of an exducer and includes a scroll housing 310 having an inlet 312, an outlet 314, a turbine 316 positioned within the housing 310, and a motor/generator 318 drivingly connected to the turbine 316. In an embodiment, the motor/generator 318 is integrated into the turbine (e.g., magnets built into the turbine 316). As best shown in FIG. 20, the system 300 further includes a variable orifice/venturi, in this embodiment a slide 320, which may take the form of a cylindrical member that is selectively movable under the control of the controller or inverter to adjust the amount and/or velocity of air entering the housing through the inlet 312. In addition, the system further includes a mid plate 322 for mounting the system 300, an inverter printed circuit board 324 connected to the housing 310, and a muffler or resonator 326 positioned mounted within the outlet downstream from the turbine 316.

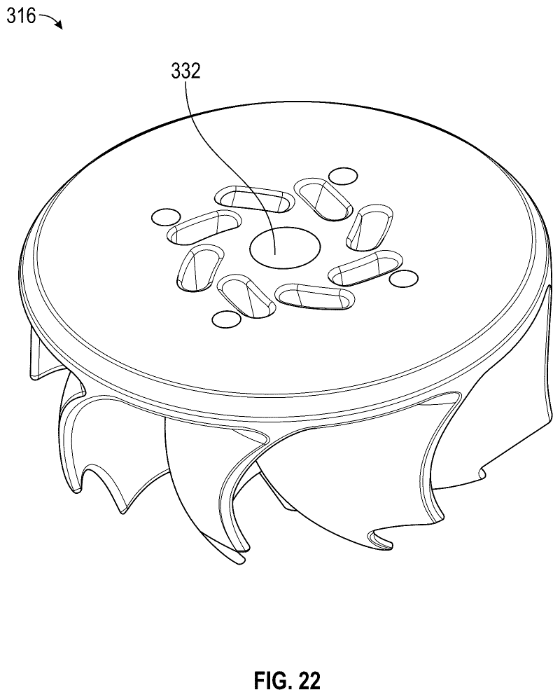

With reference to FIGS. 21-23, in an embodiment, the turbine 316 is generally circular in shape and has a central hub 332, and a plurality of vanes or blades 328 that emanate from the hub 332. In an embodiment, the hub 332 functions to align the turbine 316 to the generator 318, and to guide air smoothly 90 degrees from its entry direction (although a variety of different entry angles, or ranges thereof, are contemplated). In an embodiment, it may utilize bearings on a fixed shaft (or no shaft). In an embodiment, the blades 328 are generally arcuate in shape and have scalloped leading edges 330. It is contemplated, however, that the blades 328 may take a variety of shapes or configurations. For example, the blades may be straight and may be devoid of a scalloped leading edge. The trailing edges of the blades 328 may have scalloped edges, saw teeth and/or similar configuration. The turbine 316 may also have a plurality of bypass slots 334 or through bores which allows intake air to bypass the turbine to help cool the motor/generator 318 when needed, as discussed in detail below. In an embodiment, the volute of the turbine 316 may have one or more divisions (such that the turbine includes one, or a plurality of, distinct circumferential passages). The use of a turbine 316 with a plurality of volutes functions to reduce or eliminate radial load from uneven pressure distribution, reduces bearing load and heat, and otherwise results in increased efficiency, as a whole. In this radial-flow embodiment, the hub guides air approximately 90 degrees. In other embodiments, such as mixed-flow turbines, the air may be redirected at shallower angles (e.g., 45 degrees) for improved efficiency. In mixed flow embodiments, the flow may be between about 35 to about 60°. Such a mixed flow turbine 316 provides superior efficiency as compared to single-flow designs (such as typical turbochargers) in variable conditions.

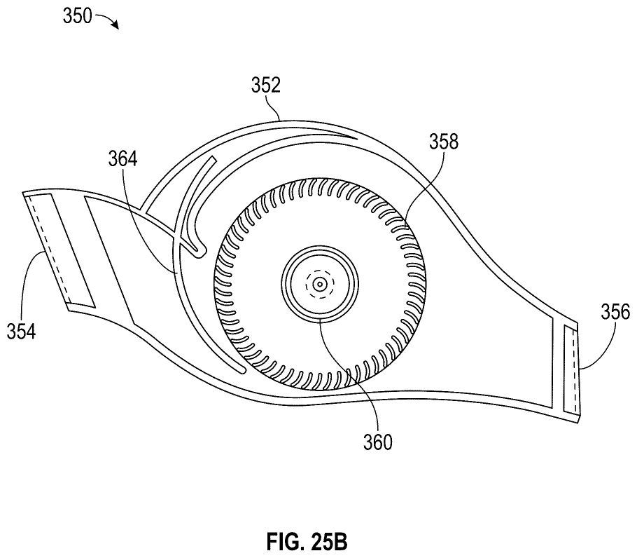

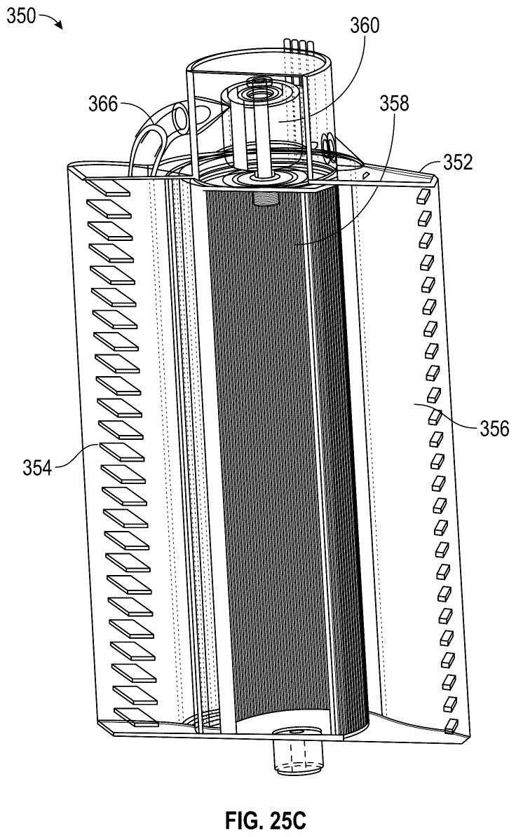

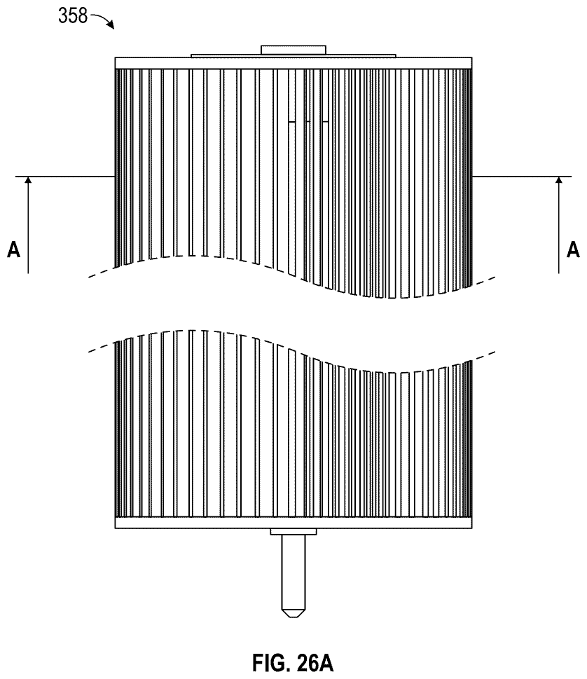

In an embodiment, the system 300 is mounted internal to the vehicle. These locations may include, but are not limited to, under the hood, behind the bumper, in wheel wells, in side scoops, in typical fog light wells, integrated with one or more wheels, underbody, integrated with side mirrors, etc. Importantly, mounting the system 300 in such areas requires no or minimal modifications to existing vehicle components/structures, allowing for easy retrofits. It is contemplated, however, that the system 300 can be mounted in other locations that may require more significant modifications to the vehicle to accommodate such system. In any case, the inlet 312 of the system 300 is in fluid communication with an exterior of the vehicle via a passageway or conduit (not shown). For example, in one embodiment, side scoops or the location of typical fog lights may serve as inlets for air to enter the passageways, which then feeds the air to the inlet 312 of the system 300. The outlet 314 of the system 300 is preferably in fluid communication with another opening in the vehicle (e.g., in front of the front tires to help entrain the air back to the side of the car to help reduce vehicle drag). In particular, the exhaust from the system may be directed to locations forward of, or rearward of, the front wheels or to other low-pressure wake regions, reducing parasitic drag. An example of this implementation is shown in, for example, FIG. 25A, discussed below. In another embodiment, the system 300 may be mounted rearward of the rear tire of the vehicle, with air inlets in the side of the vehicle, and the air outlet in a rear bumper of the vehicle (although any location where space is available can be utilized, such as the trunk lid, rear splitter, undercar and/or roofline). Moreover, as alluded to above, it is envisioned that any of the systems and devices disclosed herein can be mounted anywhere on the vehicle where there is space, and the intake and exhaust can be in any location as well.

In operation, air enters the inlet in the vehicle during forward movement of the vehicle (as well as the movement of the air itself) and travels into the system 300 via the inlet 312 in the housing 310. The kinetic wind energy, namely, the high and low pressure areas acting on the airfoil(s) of the turbine 316, causes it to rotate and drive the motor/generator 318, thus producing electrical power which can be used or stored in the manner described above.

As disclosed above, the system 300 includes a variable slide 320 to act as a variable venturi by adjusting the cross-sectional area to adjust air speed at the leading edge of the turbine 316 at lower speeds. It can be controlled to shut off airflow to the turbine 316 or open it up to balance and control airflow, turbine speed, and generator force, as needed. In an embodiment, this functionality is controlled by a controller and software to optimize power output, drag, and to watch the state of charge of the battery so as to not overcharge the vehicle traction battery. Moreover, as disclosed above, in an embodiment, the system 300 includes a muffler/¼ tune resonator 326 near the variable slide 320 to help eliminate the whistle from the turbine, airfoil, etc. A muffler/¼ tune resonator may also be provided on the intake as well (i.e., on each end of the turbine 316).

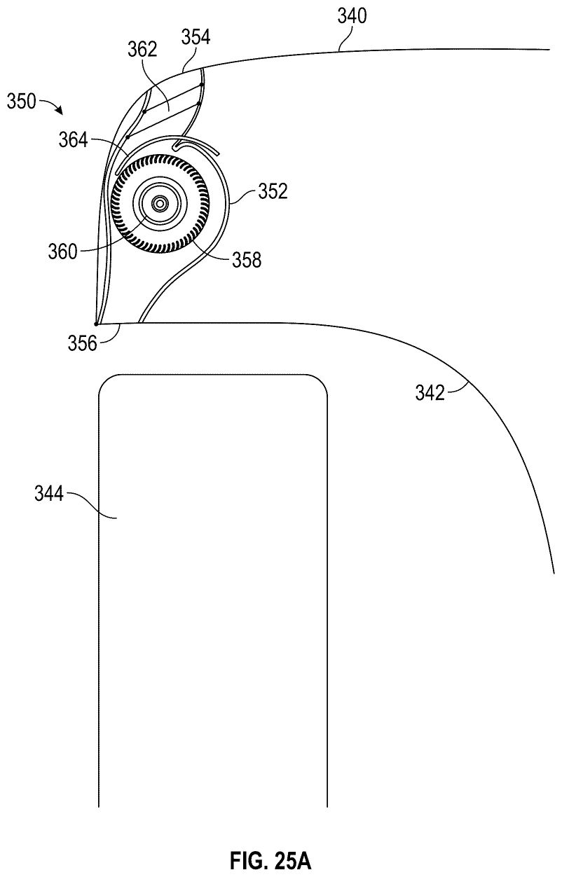

With specific reference to FIG. 24, the system 300 may include a cooling channel 336 that takes high pressure air from the fog light area (or other inlet) and feeds it up to the motor/generator 318 and the motor/generator controller 324 to cool them. The slots in the turbine 334 allow air to flow over the generator 318 and exit through the turbine 316. FIG. 24 also shows the variable slide 320 mostly closed to nozzle (speed up) the air to catch the largest outside diameter of the turbine and setup the airflow to be smooth to the radius of the turbine on the way out. This also sets up a venturi effect to help entrain the cooling air out of the motor 318.

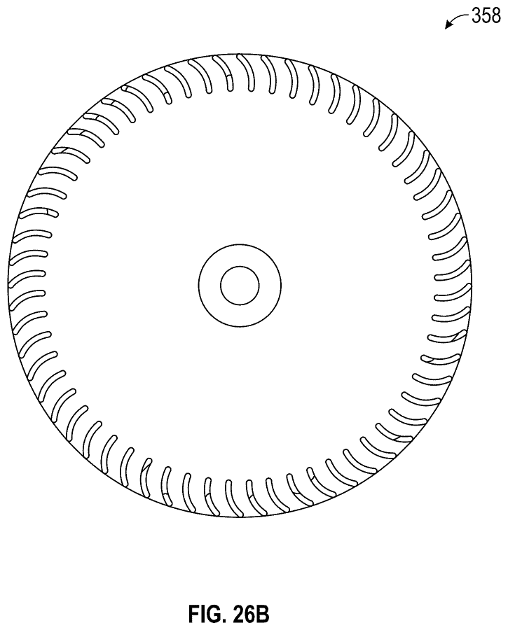

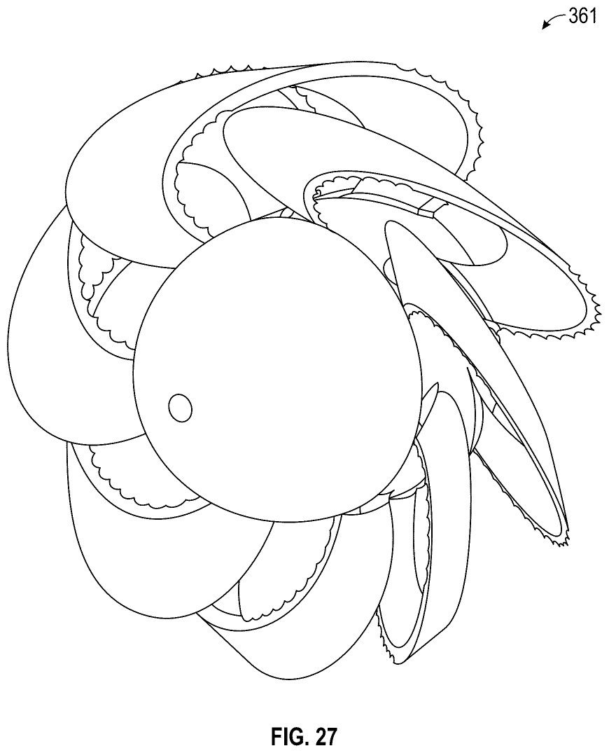

Turning now to FIGS. 25A-25C, another system 350 for harvesting kinetic wind energy is illustrated. As shown therein, the system 350 is configured to be positioned in fluid communication with an air inlet in the vehicle. For example, as best shown in FIG. 25A, the system 350 is positioned behind a bumper cover 340 of a vehicle at a front corner thereof, and forward of a wheel well 342 and wheel 344 of the vehicle. The system 350 includes a housing 352 having an inlet 354 and an outlet 356, a cross-flow turbine 358 positioned within the housing 352, and a motor/generator 360 drivingly connected to the cross-flow turbine 358. FIGS. 26A and 26B more clearly illustrate the configuration of the turbine 358. In an embodiment, the turbine 358 is oriented vertically, although other orientations are possible. As shown in FIG. 25A, the inlet 354 may include a grille 362 to inhibit the incursion of debris. In one embodiment, the inlet 354 is positioned in the typical fog light opening in the bumper cover of the vehicle. As best shown in FIG. 25B. the system 350 includes an adjustable/variable guide vane 364 that is adjustable to vary a volume of air that is permitted to enter the inlet 354 and interact with the turbine 358 (similar to guide vane 434 discussed below). As best shown in FIG. 25C, in an embodiment, the system 350 may include a cooling channel or passageway 366 extending from the inlet to the portion of the housing 352 that houses the motor/generator 360. This cooling channel 366 is utilized to divert air from the inlet 354 to the motor/generator 360 in order to cool the motor/generator 360.

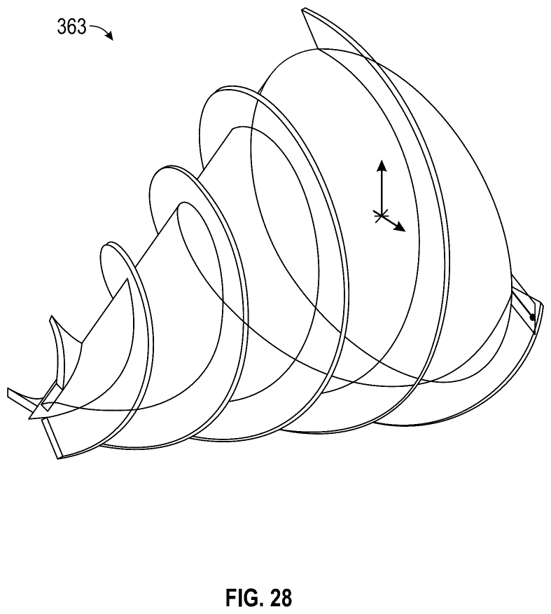

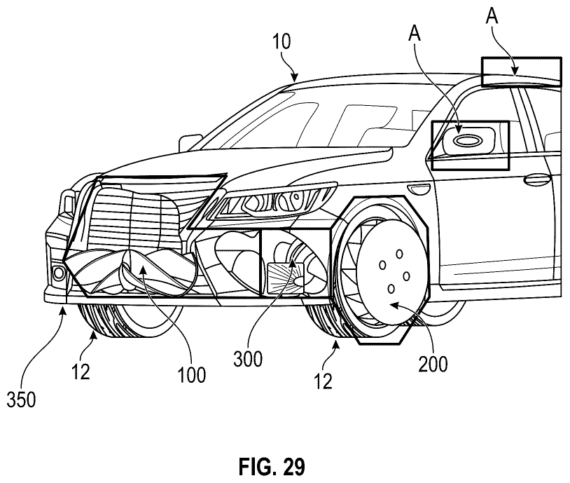

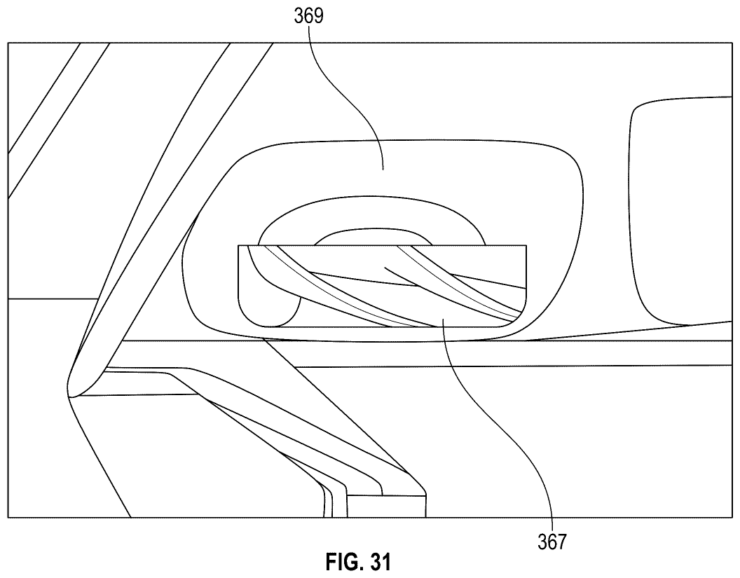

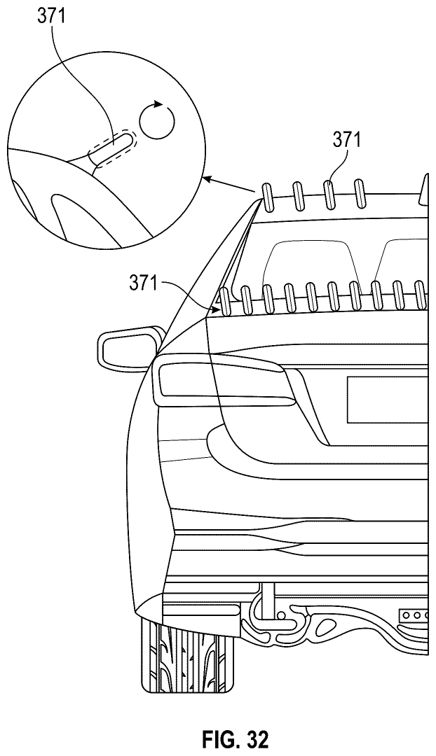

Turning to FIGS. 27 and 28, various alternative impeller/turbine devices for use in the ducted fan style energy recovery generators disclosed herein are shown. For example, FIG. 27 shows a loop/sharrow/toroidal propeller 361, where the scallops help break up vortices to further help quiet these. FIG. 28 is an Archimedes screw turbine 363. Moreover, it is contemplated that a plurality of bladeless power generator units, such as those disclosed in U.S. Pat. No. 10,641,243, may be utilized at various locations on the vehicle such as, for example, on spoilers, beneath the car, on mirrors, etc. FIGS. 31 and 32 illustrate views of a helix-style airfoil 367 integrated in the side mirror 369 of a vehicle and vortex bladeless power generator units 371 positioned along a roofline and spoiler of a vehicle, respectively.

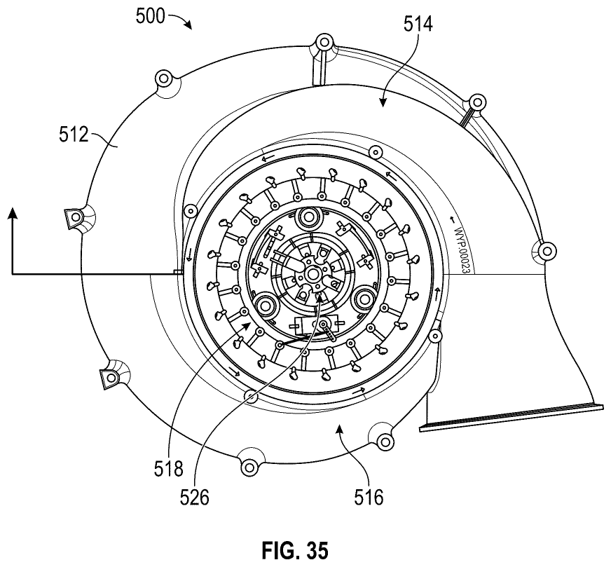

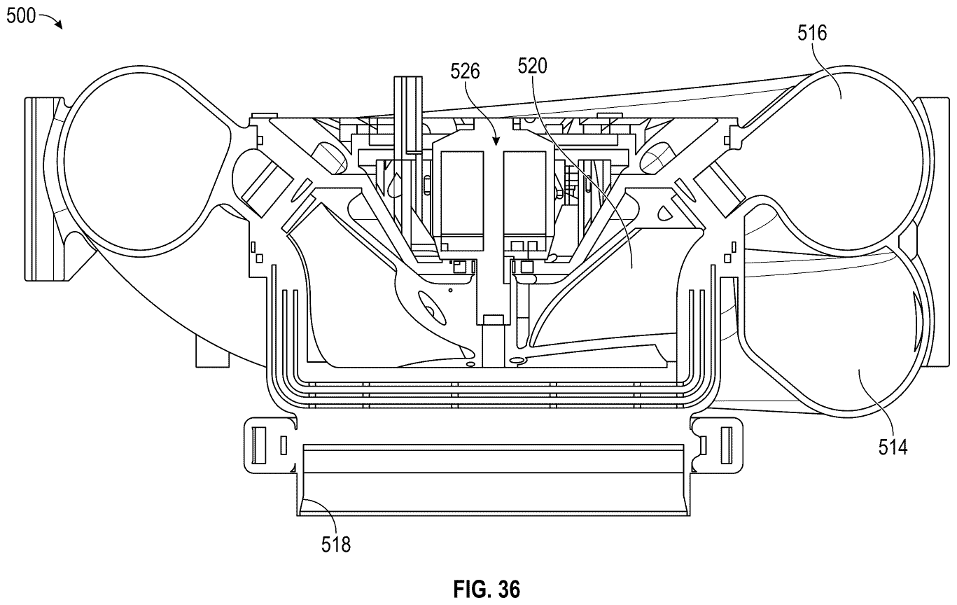

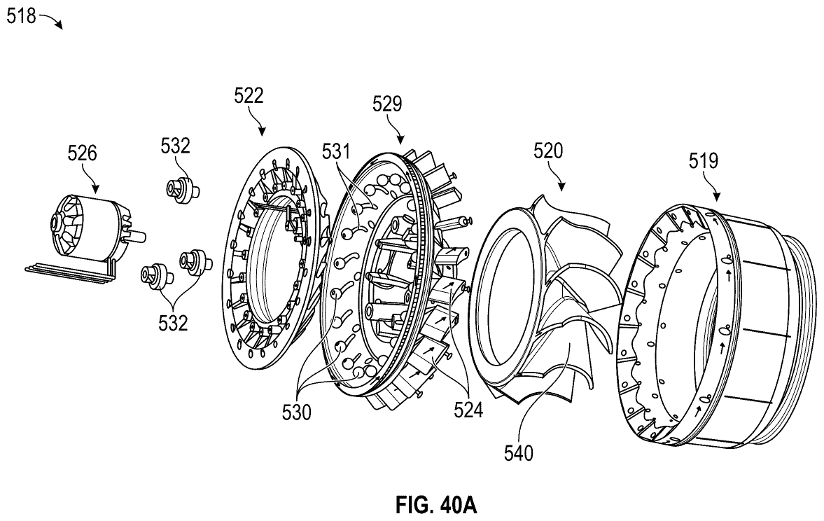

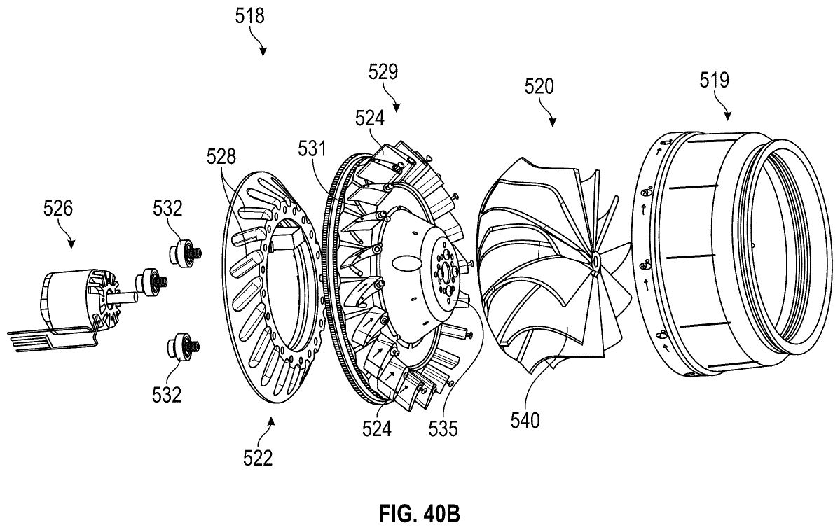

With reference to FIGS. 35-40B, another system 500 for harvesting kinetic wind energy and generating electrical power therefrom is illustrated. The system 500 is similar to the system 300 disclosed above, and is configured to be similarly located within a vehicle. As illustrated therein, the system 500 is configured as a mixed flow turbine configured for mixed flow operation, and is positioned to receive channeled thermal airflow through or along flow paths having a cross-sectional area that is constant, increasing, decreasing, or any combination thereof, normally required for vehicle cooling needs. As shown therein, the mixed flow turbine 500 incudes a housing 512 having first and second volutes 514, 516 and a central cartridge assembly 518. As best shown in FIGS. 40A and 40B, the central cartridge assembly 518 includes a generally annular or cylindrical housing 519, within which is concentrically and axially mounted a mixed flow impeller or turbine wheel 520, a rotary or main plate 522 having a generally conical or frusto-conical rear surface within which a plurality of recessed, angled slots 528 or ramps are formed and arranged in a generally annular configuration, and an assembly plate 529 having a generally conical or frusto-conical inner surface configured to nestably receive the rotary plate 522. The assembly plate 529 includes a plurality of angled slots 531 that correspond to the angled slots 528 in the rotary plate.

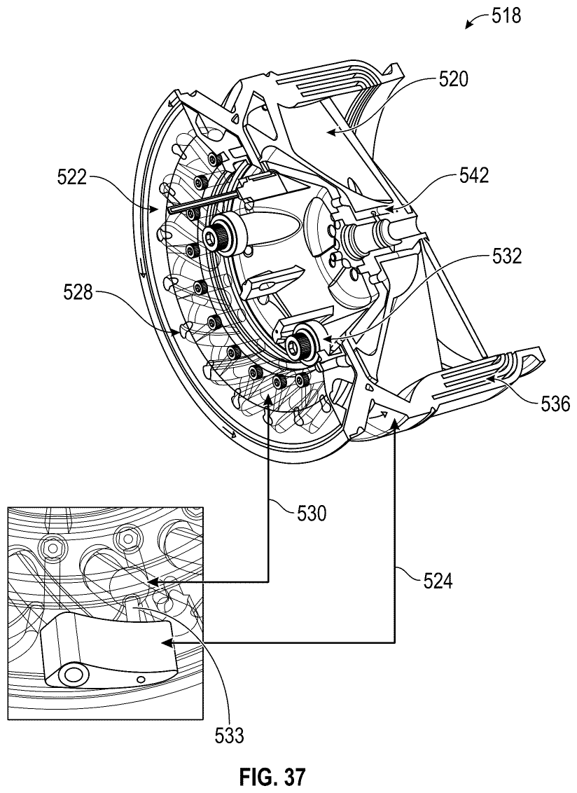

As best shown in FIGS. 37, 40A and 40B, the central cartridge assembly 518 includes a plurality of adjustable vanes 524 arranged in an annular configuration. In an embodiment, the vanes 524 may be of a variety of configurations such as, for example, flat plate blades, straight angled blades, stepped or faceted blade geometries, helical or twisted blade, spline-defined blade geometries and/or multi-element spline surfaces. Each vane 524 includes a mounting shaft or pin 533 that extends through a respective slot 531 in the assembly plate 529. A distal end of each mounting shaft 533 is mounted to a spherical interface mechanism such as, for example, a spherical ball 530. The spherical interface mechanism 530 may comprise different implementations depending on operating conditions. In high-temperature environments (such as turbocharged gasoline engines with hot under hood temperatures), a ceramic bearing or sintered bushing with a spherical outer surface may be preferred for heat resistance. In moderate temperature applications, a simple ball element provides cost-effective adjustment. In high-load or high-vibration environments, a ball bushing may be used for enhanced durability and precise linear adjustment. The choice of spherical interface mechanism can be tailored to the specific vehicle application, operating temperature range, and expected service life.

When the rotary plate 522 is nested with the assembly plate 529, the balls 530 are received in a respective angled slot 528 in the rear surface of the rotary plate 522. As discussed hereinafter, the rotary plate 522 is rotatable relative to the assembly plate 529 to adjust the position of the vanes 524. Referring still further to FIGS. 35-40B, the turbine wheel 520 is drivingly connected to a motor/generator 526, which is mounted to a hub 535 of the assembly plate 529.

The central carriage assembly 518 additionally includes one or more bearings or bushings 532. As best shown in FIGS. 35-40, the mixed flow turbine 500 additionally includes an adjustment mechanism 534 including, for example, linkages 523, an annular, toothed ring, and a servo motor 525, which are selectively operable to adjust the position of the adjustable vanes 524. In an embodiment, one or more ¼ tune resonators 536 are also employed.

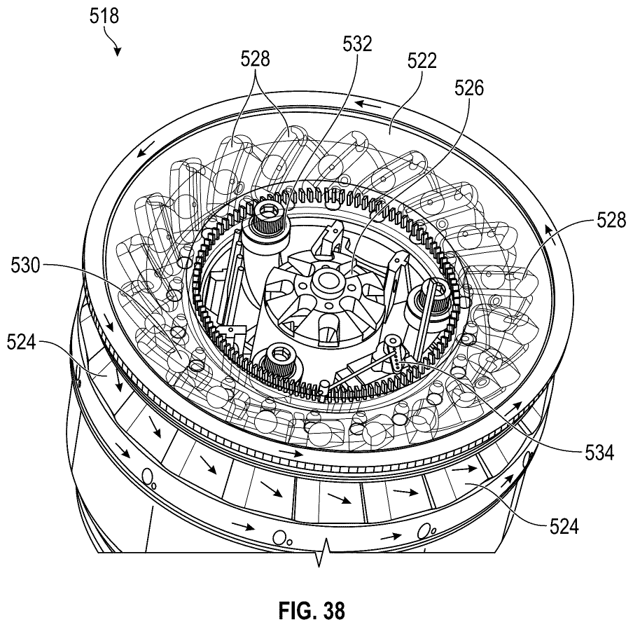

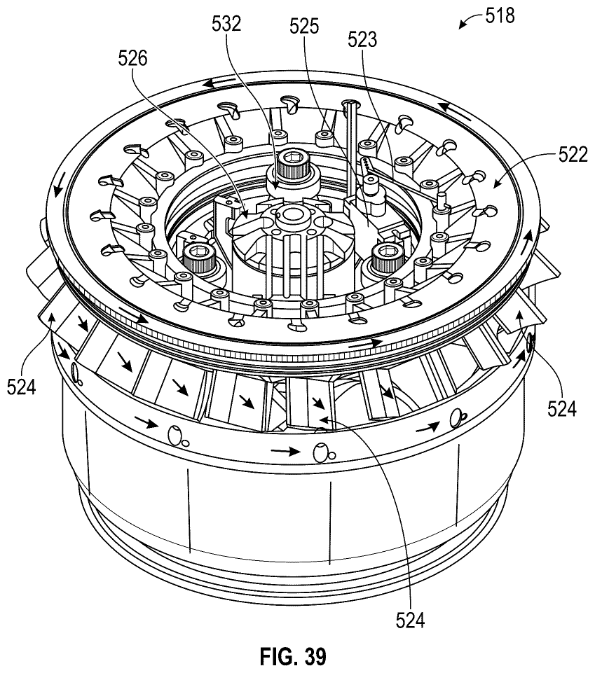

FIG. 38 illustrates the adjustable vanes 524 in a closed position, while FIG. 39 illustrates the adjustable vanes in a fully open position. In an embodiment, the vanes 524 are simultaneously adjustable, via the adjustment mechanism 534, to any intermediate positioned between the closed position and the open position. In operation, the rotary plate 522 is rotated, via the adjustment mechanism 534, relative to the assembly plate 529. This rotation causes the walls of the slots 528 of the rotary plate 522 to push against the balls 530, causing them to move along the slots/ramps 528 in the rear surface of the rotary plate 522. This movement of the balls 530 is transferred to the vanes 524 via each mounting shaft 533, causing the vanes to adjust their position (moving towards the closed position or the open position, as desired).

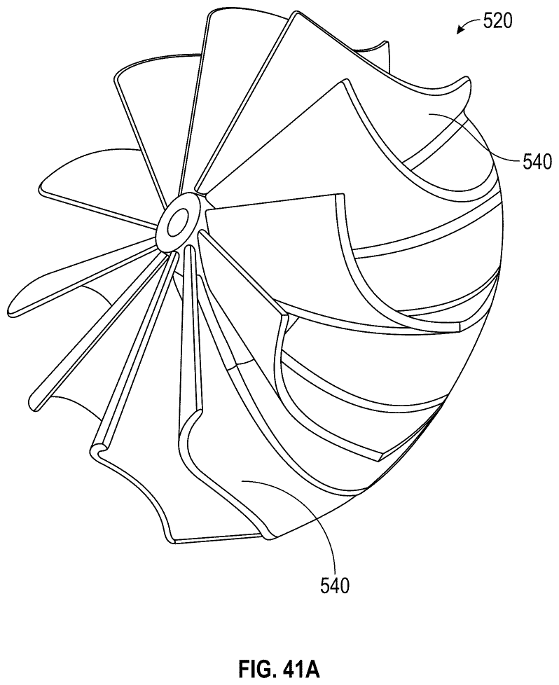

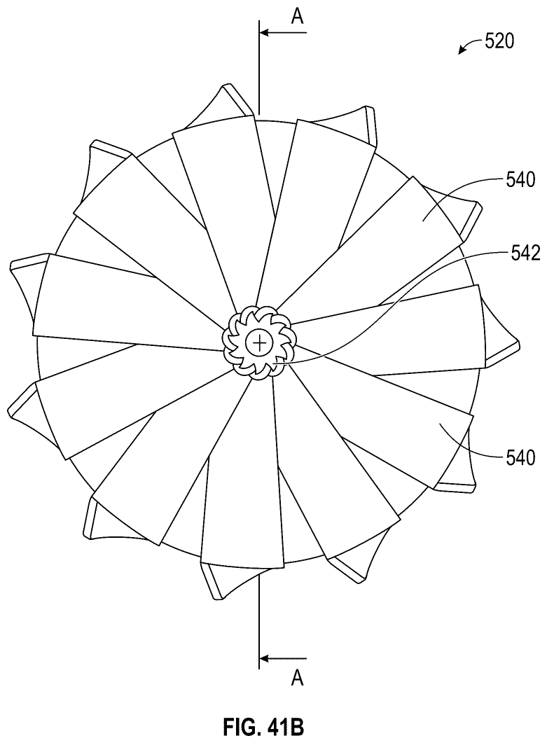

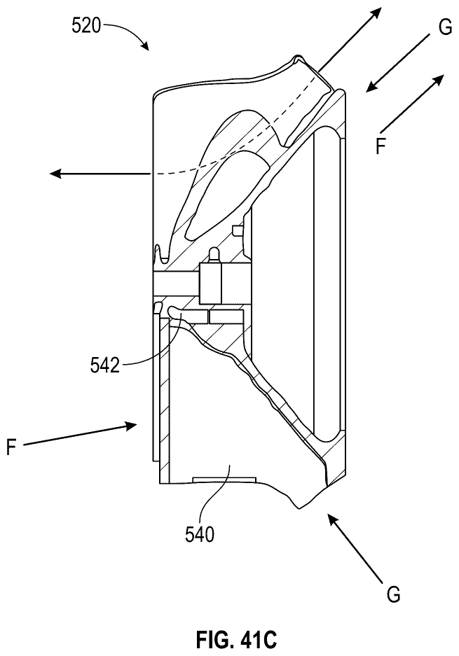

FIGS. 41A-41C more clearly illustrate the turbine wheel 520 of the mixed-flow turbine 500. As shown therein, the turbine wheel 520 includes a plurality of arcuate, angled blades 540 and a colling channel 542. As best illustrated in FIG. 41C, the mixed flow turbine 500 and turbine wheel 520 allow for bidirectional airflow, including flow in the direction of arrow, G, in generator mode, and flow in the direction of arrow, F, in fan or cooling mode. The configuration of the blades 540 deflects air at about 45° (instead of 90° for a radial turbine).

The mixed flow turbine 500 advantageously combines the torque advantages of radial-flow with the throughput capabilities of axial-flow designs. In particular, the use of adjustable vanes 524 to alter the area-to-radius (A/R) ratio of the turbine housing, allows the turbine 500 to optimize performance across a broad range of operational conditions and wind speeds. In particular, these vanes 524 form a controllable nozzle to optimize thermal shedding flow needs, drag penalty, and energy recovery potential. This is known as variable geometry or variable A/R ratio control. This variable geometry is also present in system 400 (variable guide vanes 434), and provides similar functionality, and may be incorporated into any of the systems disclosed herein.

In wind applications, the radial component provides high starting torque enabling operation at lower wind/driving speeds than traditional axial turbines, while the axial component maintains efficiency at higher flow rates. This dual characteristic enables efficient energy extraction across a wider operational envelope. The technology makes wind power viable in previously unsuitable locations including urban environments with variable wind patterns, building-integrated applications with turbulent flow, and low-wind regions where traditional turbines cannot operate economically. Arrays may combine mixed-flow with cross-flow turbines for optimized startup and operational characteristics across all wind conditions.

Importantly, in the embodiments disclosed herein, the typical air intake of the vehicle (e.g., through the front end grille of the vehicle, side scoops or the like) may be utilized for typical cooling functionality by passing the air through one or more heat exchangers (e.g., a vehicle radiator), as well as energy recovery using the energy recovery/harvesting systems disclosed herein. Accordingly, typical intake airflow serves both vehicle cooling purposes and is passed to the turbine(s) for energy recovery. As will be appreciated, the thermal system airflow (e.g., through a channel/passageway leading to a radiator) is a source of drag but is required for cooling. The embodiments of the invention thus recover this energy using the air that passes through the typical cooling/thermal management system of the vehicle. In particular, the system of the invention disclosed herein provide for the recovery of energy from airflow paths that are already required for vehicle thermal management, thereby imposing a minimal or nominal additional aerodynamic penalty on the vehicle, as a whole. In an embodiment, the airflow first passes through the turbine for energy recovery, and then passes through the heat exchanger. Alternatively, however, the airflow may first be passed through the heat exchanger for cooling or heat pump operations, then the turbine(s) for energy harvest.

The systems of the invention disclosed herein extract power from the relative motion between the vehicle and surrounding air, wherein the vehicle's forward movement through stationary air creates the primary airflow driving force, analogous to pushing a radiator through air rather than using a fan to pull air through a stationary radiator. This relative velocity airflow is accelerated through tapered inlet ducting that converts static pressure to dynamic pressure following Bernoulli's principle, with the resulting velocity increase providing greater energy recovery availability. The natural pressure differential between the vehicle's high-pressure frontal zones (approximately 1.0 pressure coefficient) and low-pressure wake regions (approximately −0.2 to −0.6 pressure coefficient) provides supplementary flow assistance that helps maintain airflow velocity across the turbine during work extraction, preventing flow stalling that would otherwise occur from energy removal. The controller optimizes the system to balance drag with extracting available energy while maintaining sufficient flow for vehicle thermal management requirements, with the pressure differential between inlet and outlet zones assisting flow velocity despite the work performed. While wake filling could theoretically be achieved through simple ducting without energy recovery, extracting available kinetic energy from airflow that must occur for cooling and aerodynamic purposes regardless represents an efficient capture of otherwise wasted energy, with the system providing the multiple benefits of drag reduction through wake filling while simultaneously generating electrical energy recovery for vehicle use or storage.

In the embodiments described above, the turbines of the invention may also be configured for bidirectional operation, which enables the turbine fan direction or functionality to be reversed for active fan cooling during towing/race conditions (pushing air through the on-board heat exchangers). This enables the turbine direction or functionality be reversed from generator mode or direction to fan mode or direction. Moreover, this bidirectional operation enables active cooling when needed and energy recovery when available. In any of the embodiments disclosed herein, one or more backup fans may be employed to provide extra cooling when needed beyond passive airflow capabilities (such as when towing heavy loads or during extreme operating conditions).

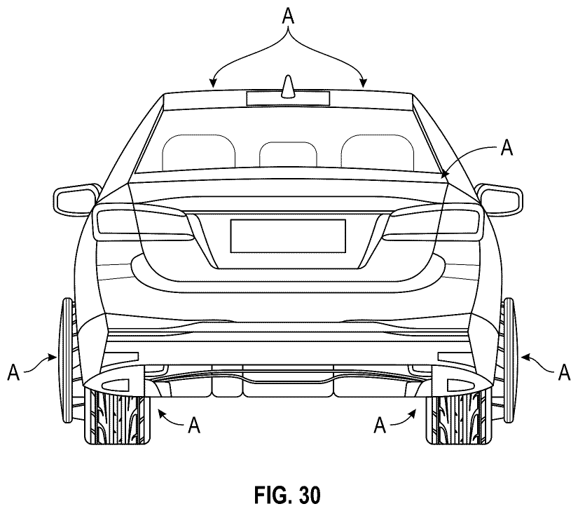

As indicated above, the motor/generators disclosed herein may be any type of motor/generator known in the art configured to convert a rotational input into electrical power (e.g., direct-shaft driven, magnetic coupling/magnetically driven, linear motor, piezoelectric motor, etc.). Moreover, in any of the embodiments disclosed herein, one or more of the systems may include an adjustable bypass, nozzle or venturi at the respective intake(s), which can help adjust aerodynamic drag, control generator speed, and the like. It is further contemplated that the systems and devices disclosed herein may be located at a variety of locations within the vehicle including, for example, in the side mirrors, the spoiler, under the cargo area, etc. FIGS. 29 and 30 illustrate by arrows A, locations where energy recover devices according to embodiments of the invention may be located.

It is contemplated that, in an embodiment, a vehicle may include a plurality of systems and devices for harvesting kinetic wind energy. These systems/devices may be arranged in series, in parallel, and various combinations thereof. For example, in a multi-device, multi-turbine system, a vehicle may include one or more mixed-flow turbines of the type and at a location on the vehicle as disclosed herein, as well as one or more cross-flow turbines of the type and at a location on the vehicle as disclosed herein. Such a configuration allows for maximum kinetic energy harvest/recovery at both highway speeds and at lower speed. In particular, it has been discovered that mixed-flow turbines are optimal for highway speeds and high pressure ratios, while cross-flow turbines are optimal in stop-and-go traffic, at lower speeds (e.g., less than 30 mph) and parking lot speeds. In one embodiment, for example, a delivery vehicle may use an on-board cross-flow turbine for harvesting kinetic wind energy when traveling between stops (at lower traveling speeds), and an on-board mixed-flow turbine when traveling on highways. Such systems are configured to complement, but not replace, regenerative braking systems on board the vehicle (when present). For example, in an embodiment, the systems disclosed herein are configured to harvest kinetic wind energy for power generation and/or battery charging when regenerative braking is inactive (e.g., during a cruise mode of operation), ensuring continuous recovery during all times a vehicle is in operation, regardless of state (braking, cruising, parked, accelerating). In an embodiment, the systems may be designed to replace regenerative braking. In an embodiment where the turbine systems/devices of the invention are arranged in series, they may be arranged in states (e.g., high pressure, medium pressure and low pressure stages), which is beneficial in that more total energy recovery can be realized as a result of the available pressure drop between stages.

As will be appreciated, the present invention therefore provides a variety of systems and devices for harvesting the aerodynamic/wind energy generated during vehicle movement, which can then be used to drive a motor/generator to generate power for use in vehicle propulsion, recharging of on-board batteries, or supplementing traction motors. Moreover, the systems disclosed herein may also be utilized to charge the vehicle energy storage system or auxiliary energy storage system (e.g., on-board batteries) while parked (i.e., not moving) so long as wind or airflow is present. This feature may be important, for example, during power outages, during natural disasters, or when in a remote location. As alluded to above, it is contemplated that any number of these different systems may be deployed on any given vehicle to maximize energy harvest. The present invention thus provides an electric vehicle with extended range with a much lighter battery and reduced carbon footprint, reduced precious minerals, more interior space, longer battery life, overall reduced vehicle weight not having to support the extra battery weight, overall reduced costs, reduced charging frequency, reduced strain on the grid, and reduced cost per mile.

While the embodiments disclosed herein discuss the systems and devices for use on vehicles such as cars, trucks, trains and the like, for recovering kinetic wind energy to generate power, it is not intended that the invention be so limited in this regard. In particular, it is contemplated that the systems and devices disclosed herein may be deployed on watercraft, aircraft, and the like. Moreover, it is further contemplated that the systems and devices disclosed herein can be either OEM equipment integrated into the vehicle as delivered to a customer, and/or can be retrofit into existing vehicles. In an embodiment, the disclosed systems and devices are practically implemented into such vehicles. As used herein, “practically implemented” means that standard vehicle architecture is maintained, requires less than about 10% chassis volume modification, preserves ground clearance within about 2 inches, is installable without needing to relocate traction batteries, motors, fuel tank, or occupant seats.

In the embodiments disclosed above, the various systems and devices of the invention are configured and positioned so as to intake air from high-pressure zones/regions adjacent to the vehicle, and exhausts the air to low-pressure/vacuum zones/regions. For example, for the system 100 with airfoil/turbine 110 mounted at the front of the vehicle intakes air from the vehicle front where the pressure coefficient may be about 1.0, and exhausts air to a location behind the front tires, where the pressure coefficient may be between about −0.2 to about −0.6. Accordingly, making use of these pressure differentials adds recoverable energy to effective flow velocity beyond ambient wind speed/vehicle speed. Further to the above, in an embodiment, the exhaust from the turbine systems/devices disclosed herein is directed to low-pressure wake regions, reducing parasitic drag. This results in energy recovery while improving vehicle aerodynamics.

It is further envisioned that any of the embodiments of the invention can include one or more weatherproofing devices to ensure all-weather operation. These devices may include, for example, screens for debris management, holes and/or debris dump valve for water drainage, heaters for inhibiting ice buildup, and the like.

Lastly, while the invention has been shown and described in the context of electric vehicles, it is not intended that the present invention be so limited in this regard. In particular, the systems and devices disclosed herein can be integrated into any other vehicles, buildings, structures and devices to capture wind or aerodynamic energy that may otherwise be wasted.

In any implementation, the various systems disclosed herein may be communicatively coupled to a controller or central processing unit or similar device such as, for example, an inverter. The controller may be utilized to communicate requests with the vehicle and system operations, and for example, to control use (or non-use) of the power generated (including to control recharging of on-board energy storage systems).

In particular, the control system of the vehicle may include a processor/microcontroller, inverter for controlling electric motors/generators, sensors, communications, memory, bidirectional DC-DC converter etc., collectively referred to herein as the energy recovery control system. The energy recovery control system communicates with existing vehicle systems and components like the battery management system (BMS) to get state of charge, maximum charge current, etc. Many other control modules also communicate info such as traction motor torque request(s), braking position, handling modes, steering inputs, torque vectoring, etc. from the vehicle. In an embodiment, the onboard energy recovery inverter has sensors for acceleration, gyroscope, pressure/pressure differential across the turbine, vibration, sound, phase currents, airflow, phase voltages, direct current and voltage, variable slide position, etc., which are analyzed by the control loop which adjusts system goals, positioning, etc. and checks for errors. In an embodiment, feedback indicating out of balance components, resonant rpms to avoid, harsh frequencies, results in parameter adjustment or, where feedback warrants, system shutdown.

In an embodiment, the energy recovery control system may operate according to algorithms stored in memory and may utilize artificial intelligence and/or machine learning to determine and set optimum device settings from one or more of the above-described inputs for energy recovery, drag increase or reduction, maximum or efficient energy recovery, etc., and is configured to adjust the variable orifices/venturis such as a slide position on an (inlet and/or outlet), etc. for individual, groups of, or specific energy recovery devices. The system may learn over time or may operate according to a fixed algorithm.

As is understood, a generator using a bridge rectifier has diode losses and has a low degree of freedom of recovered output power. An active or synchronous rectification method has lower losses but still has a low degree of control freedom of output energy. This low control level limits the system to a narrow range of useful device functionality. The present invention, however, employes an inverter, which allows for a high resolution of freedom of energy recovery level. This allows, for example, optimizing electrical energy recovery with minimized aerodynamic drag.

In an embodiment, the present invention may utilize a multi-asynchronous Pulse Width Modulation (PWM) control algorithm which seeks to balance maximum energy recovery power output with low EMI (ElectroMagnetic Interference generated from component resonances, inductive collapse, etc.), low audible harmonics, back electromotive force (EMF), optimized aerodynamic drag, and the least kinetic energy consumption. This is achieved by defining and optimizing how many PWM pulse pairs (drive and receive) per alternating current cycle and aligning the multiple drive and receive pulses to best fit the motor back EMF waveform while meeting these goals. The drive pulse feeds an optimized timing and duration pulse of energy into the motor/generator coil. Then the optimized timing and duration asynchronous receive pulse most efficiently recovers the inductive collapse and some kinetic energy from the system. The PWM pulses utilize the inverter power switches (vs. using the body diodes as is typical in inverters) to most efficiently collect the system energy. In another embodiment, Gallium Nitride mosfets (GaN FETs) may also be utilized with or without these techniques. It is also possible to perform PWM injection to have the motor emit audible sounds, e.g., EV warning sounds.

In an embodiment, one or more of the systems described above may include a heater to help deal with weather, but which can also double as an energy sink, if required. Use of the heater as a sink may occur, for example, when the vehicle batteries are fully charged, or when there is any unexpected contactor disconnect. This energy dump in the event of a contactor disconnect would turn on the heater to absorb/consume the energy that would otherwise run away and destroy the inverter power switches with overvoltage.

As indicated above, it is also to be understood that the systems described above may include the necessary electronics, software, memory, storage, databases, firmware, logic/state machines, microprocessors, communication links, displays or other visual or audio user interfaces, and any other input/output interfaces or sensors to perform the functions described herein and/or to achieve the results described herein which may be in real-time. For example, as previously mentioned, the system may include at least one processor and system memory/data storage structures, which may include random access memory (RAM) and read-only memory (ROM). The at least one processor of the system may include one or more conventional microprocessors and one or more supplementary co-processors such as math co-processors or the like. The data storage structures discussed herein may include an appropriate combination of magnetic, optical and/or semiconductor memory, and may include, for example, RAM, ROM, flash drive, an optical disc such as a compact disc and/or a hard disk or drive. In an embodiment, software for controlling and operating the systems disclosed herein may receive over the air updates and may be configured for communication with remote servers for storing data in the cloud.

Additionally, a software application that adapts the controller to perform the methods disclosed herein may be programmed or uploaded/written into a main memory of the at least one processor from a computer-readable medium. The term “computer-readable medium”, as used herein, refers to any medium that provides or participates in providing instructions or system settings and optimizations to the at least one processor of the system(s) (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a RAM, a PROM (programmable read only memory), an EPROM (erasable programmable read-only memory) or EEPROM (electronically erasable programmable read-only memory), a FLASH, any other memory chip or cartridge, or any other medium from which a computer can read and/or store.

While in embodiments, the execution of sequences of instructions in the software application causes at least one processor to perform the methods/processes described herein, hard-wired circuitry may be used in place of, or in combination with, software instructions for implementation of the methods/processes of the present invention. Therefore, embodiments of the present invention are not limited to any specific combination of hardware and/or software.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A system for harvesting kinetic wind energy, comprising:
a turbine assembly configured for positioning within an air flow passageway within a vehicle, the turbine assembly being configured to receive an inlet flow of air from the air flow passageway; and
a motor/generator drivingly connected to the turbine assembly and being configured to generate electrical power from the inlet flow of air.

2. The system of claim 1, wherein:
the vehicle is a passenger vehicle; and
wherein the turbine assembly is located intermediate a front grille of the vehicle and a radiator of the vehicle.

3. The system of claim 1, wherein:
the turbine assembly is a cross-flow turbine.

4. The system of claim 2, wherein:
the turbine assembly includes a plurality of helical vanes.

5. The system of claim 1, wherein:
the turbine assembly is a mixed-flow turbine.

6. The system of claim 5, wherein:
the mixed-flow turbine includes a divided volute configured to balance bearing loads from asymmetric airflow conditions.

7. The system of claim 5, wherein:
the mixed-flow turbine assembly includes a plurality of adjustable A/R vanes.

8. The system of claim 1, wherein:
the vehicle is one of a passenger automobile, a truck, a bus, a train, a semi-truck, a motorcycle, an airplane, and a watercraft.

9. The system of claim 1, wherein:
the turbine assembly is integrated with a wheel of the vehicle.

10. The system of claim 1, wherein:
the turbine assembly is integrated with a side mirror of the vehicle.

11. The system of claim 1, wherein:
the motor/generator is integrated with the turbine assembly.

12. The system of claim 1, further comprising:
a second turbine assembly for positioning within an air flow passageway within a vehicle in series or in parallel with the turbine assembly; and
a second motor/generator drivingly connected to the turbine assembly and being configured to generate electrical power.

13. A vehicle, comprising:
a plurality of wheels;
at least one electric motor configured to provide motive power for driving the plurality of wheels;
at least one energy storage system electrically connected to the at least one electric motor for powering the at least one electric motor; and
at least one turbine assembly configured to receive a flow of air and to convert the flow of air into electrical power.

14. The vehicle of claim 13, further comprising:
a control system for controlling the flow of electrical power from the at least one turbine assembly to a storage device or to a load.

15. The vehicle of claim 13, wherein:
the at least one turbine assembly is a plurality of turbine assemblies arranged in series.

16. The vehicle of claim 13, wherein:
the at least one turbine assembly is a plurality of turbine assemblies arranged in parallel.

17. The vehicle of claim 13, wherein:
the at least one turbine assembly includes a mixed-flow turbine and a motor/generator drivingly connected to the mixed-flow turbine.

18. The vehicle of claim 17, wherein:
the at least one turbine assembly includes a plurality of adjustable vanes.

19. The vehicle of claim 13, further comprising:
a heat exchanger located within an air flow pathway of the vehicle, the heat exchanger being configured to provide for cooling of one or more components of the vehicle;
wherein the at least one turbine assembly is located intermediate an inlet of the air flow pathway and the heat exchanger.

20. A method for harvesting kinetic wind energy, comprising:
routing a flow of air during operation of a vehicle into an air flow pathway of the vehicle;
directing the flow of air into a turbine assembly to rotate the turbine assembly; and
with the rotational output of the blade assembly, driving a motor/generator to produce electrical power for consumption by the vehicle and/or storage in at least one battery of the vehicle.

21. The method according to claim 20, wherein:
the turbine assembly is a mixed-flow turbine; and
wherein the method further includes the step of adjusting a position of vanes of the turbine assembly in dependence upon an operational condition of the vehicle.

22. A turbine assembly, comprising:
an inlet passage configured to receive a flow of air;
a turbine wheel mounted on an axis and being configured to receive the flow of air from the turbine inlet passage
an outlet passage configured to receive the flow of air from the turbine wheel;
a plurality of guide vanes, the guide vanes being selectively adjustable to control an amount of air provided to the turbine wheel; and
a mechanical adjustment mechanism operable to control a position of the plurality of guide vanes.

23. The turbine assembly of claim 22, wherein:
the mechanical adjustment mechanism includes a spherical ball associated with each of the plurality of guide vanes, and a corresponding angled surface associated with each of the spherical balls.
